(19) United States
(12) Patent Application Publication
(10) Pub. No.: US 2026/0040127 A1
(43) Pub. Date: Feb. 5, 2026

(54) METHOD AND APPARATUS FOR CSI REPORTING IN MULTI-TRP SCENARIOS

(71) Applicant: Samsung Electronics Co., Ltd., Suwon-si (KR)

(72) Inventors: Gilwon Lee, Prosper, TX (US); Md. Saifur Rahman, Plano, TX (US); Eko Onggosanusi, Coppell, TX (US)

(21) Appl. No.: 19/353,537

(22) Filed: Oct. 8, 2025

Related U.S. Application Data
(63) Continuation of application No. 18/305,241, filed on Apr. 21, 2023, now abandoned.
(60) Provisional application No. 63/338,752, filed on May 5, 2022.
(60) Provisional application No. 63/343,847, filed on May 19, 2022.
(60) Provisional application No. 63/400,300, filed on Aug. 23, 2022.
(60) Provisional application No. 63/400,632, filed on Aug. 24, 2022.
(60) Provisional application No. 63/413,890, filed on Oct. 6, 2022.
(60) Provisional application No. 63/415,554, filed on Oct. 12, 2022.
(60) Provisional application No. 63/415,875, filed on Oct. 13, 2022.
(60) Provisional application No. 63/459,908, filed on Apr. 17, 2023.

(51) Int. Cl. H04W 24/10; H04B 7/06; H04L 5/00; H04W 24/08

(52) U.S. Cl. CPC H04W 24/10; H04B 7/0626; H04L 5/0035; H04L 5/0051; H04W 24/08

(57) ABSTRACT

Apparatuses and methods for channel state information (CSI) reporting in multi-transmission reception point (TRP) operations in wireless networks. A method performed by a user equipment (UE) includes receiving information about a CSI report. The information indicates Nₜᵣₚ CSI reference signal (CSI-RS) resources, where Nₜᵣₚ>1. The method further includes, based on the information, measuring the Nₜᵣₚ CSI-RS resources and determining the CSI report associated with N≤Nₜᵣₚ CSI-RS resources, where N∈{1,2, . . . , Nₜᵣₚ}. The CSI report includes a strongest coefficient indicator (SCI) for each layer l (SCIₗ). The SCIₗ indicates an index of a strongest coefficient among

$${K}_{l}^{N Z}$$

coefficients. l∈{1, . . . , v} is a layer index, v≥1 is a rank value, and

$${K}_{l}^{N Z}$$

is a total number of non-zero coefficients for a layer l associated with CSI-RS ports corresponding to the N CSI-RS resources. The method further includes transmitting the CSI report.

### CROSS-REFERENCE TO RELATED APPLICATION AND CLAIM OF PRIORITY

This application is a continuation of U.S. patent application Ser. No. 18/305,241 filed on Apr. 21, 2023, which claims priority under 35 U.S.C. § 119 (e) to U.S. Provisional Patent Application No. 63/338,752 filed on May 5, 2022, U.S. Provisional Patent Application No. 63/343,847 filed on May 19, 2022, U.S. Provisional Patent Application No. 63/400,300 filed on Aug. 23, 2022, U.S. Provisional Patent Application No. 63/400,632 filed on Aug. 24, 2022, U.S. Provisional Patent Application No. 63/413,890 filed on Oct. 6, 2022, U.S. Provisional Patent Application No. 63/415,554 filed on Oct. 12, 2022, U.S. Provisional Patent Application No. 63/415,875 filed on Oct. 13, 2022, and U.S. Provisional Patent Application No. 63/459,908 filed on Apr. 17, 2023. The above-identified provisional patent applications are hereby incorporated by reference in their entirety.

### TECHNICAL FIELD

The present disclosure relates generally to wireless communication systems and, more specifically, to electronic devices and methods for channel state information (CSI) reporting in multi-transmission reception point (TRP) operations in wireless networks.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure relates to apparatuses and methods for CSI reporting in multi-TRP (mTRP) operations.

In one embodiment, a user equipment (UE) is provided. The UE includes a transceiver configured to receive information about a CSI report. The information indicates Nₜᵣₚ CSI reference signal (CSI-RS) resources, where Nₜᵣₚ>1. The UE further includes a processor operably coupled to the transceiver. The processor, based on the information, is configured to measure the Nₜᵣₚ CSI-RS resources and determine the CSI report associated with N≤Nₜᵣₚ CSI-RS resources, where N∈{1, 2, . . . , Nₜᵣₚ}. The CSI report includes a strongest coefficient indicator (SCI) for each layerl (SCIₗ). The SCIₗ indicates an index of a strongest coefficient among

$${K}_{l}^{NZ}$$

coefficients. l∈{1, . . . , v} is a layer index, v≥1 is a rank value, and

$${K}_{l}^{NZ}$$

is a total number of non-zero coefficients for a layer l associated with CSI-RS ports corresponding to the N CSI-RS resources. The transceiver is further configured to transmit the CSI report.

In another embodiment, a base station (BS) is provided. The BS includes a processor configured to identify information about a CSI report. The information indicates Nₜᵣₚ CSI-RS resources, where Nₜᵣₚ>1. The BS further includes a transceiver operably coupled to the processor. The transceiver is configured to transmit the information about the CSI report and receive the CSI report including SCₗ. The CSI report is associated with N≤Nₜᵣₚ CSI-RS resources, where N∈{1, 2, . . . , Nₜᵣₚ}. The SCIₗ indicates an index of a strongest coefficient among

$${K}_{l}^{NZ}$$

coefficients. l∈{1, . . . , v} is a layer index, v≥1 is a rank value, and

$${K}_{l}^{NZ}$$

is a total number of non-zero coefficients for a layer l associated with CSI-RS ports corresponding to the N CSI-RS resources.

In yet another embodiment, a method performed by a UE is provided. The method includes receiving information about a CSI report. The information indicates Nₜᵣₚ CSI-RS resources, where Nₜᵣₚ>1. The method further includes, based on the information, measuring the Nₜᵣₚ CSI-RS resources and determining the CSI report associated with N≤Nₜᵣₚ CSI-RS resources, where N∈{1, 2, . . . , Nₜᵣₚ}. The CSI report includes SCIₗ. The SCIₗ indicates an index of a strongest coefficient among

$${K}_{l}^{NZ}$$

coefficients. l∈{1, . . . , v} is a layer index, v≥1 is a rank value, and

$${K}_{l}^{NZ}$$

is a total number or non-zero coefficients for a layer l associated with CSI-RS ports corresponding to the N CSI-RS resources. The method further includes transmitting the CSI report.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIG. 4 illustrates an example antenna blocks or arrays forming beams according to embodiments of the present disclosure;

FIG. 5 illustrates an example distributed multiple-input multiple-output (MIMO) system according to embodiments of the present disclosure;

FIG. 6 illustrates an example distributed MIMO system according to embodiments of the present disclosure;

FIG. 7 illustrates an example antenna port layout according to embodiments of the present disclosure;

FIG. 8 illustrates a 3D grid of oversampled discrete Fourier transform (DFT) beams according to embodiments of the present disclosure;

FIG. 9 illustrates two new codebooks according to embodiments of the present disclosure;

FIG. 10 illustrates an example distributed MIMO system where each TRP has a single antenna panel according to embodiments of the present disclosure;

FIG. 11 illustrates an example distributed MIMO system where each TRP has a multiple antenna panels according to embodiments of the present disclosure;

FIG. 12 illustrates an example distributed MIMO system where each TRP can be a single panel or a multiple panel according to embodiments of the present disclosure; and

FIG. 13 illustrates a flowchart of an example method for operating a UE according to embodiments of the present disclosure.

### DETAILED DESCRIPTION

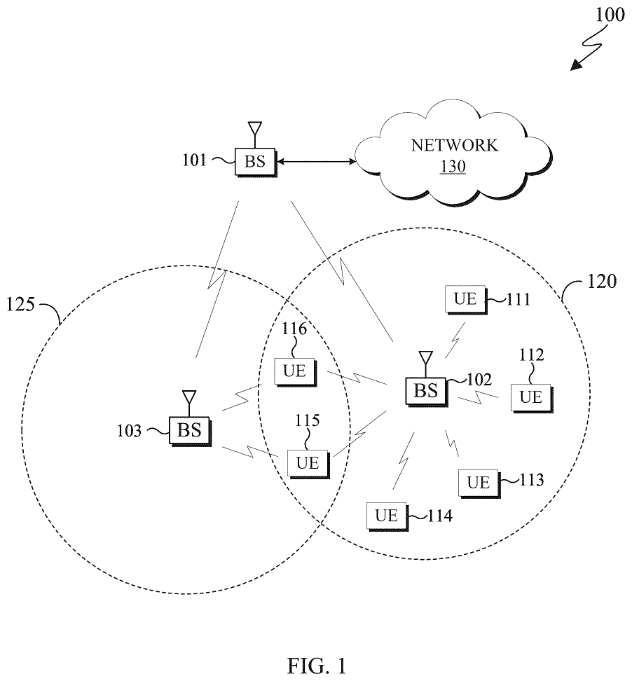

FIGS. 1 through 13, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

The following documents and standards descriptions are hereby incorporated by reference into the present disclosure as if fully set forth herein: 3GPP TS 36.211 v17.2.0, “E-UTRA, Physical channels and modulation” (herein “REF 1”); 3GPP TS 36.212 v17.2.0, “E-UTRA, Multiplexing and Channel coding” (herein “REF 2”); 3GPP TS 36.213 v17.2.0, “E-UTRA, Physical Layer Procedures” (herein “REF 3”); 3GPP TS 36.321 v17.1.0, “E-UTRA, Medium Access Control (MAC) protocol specification” (herein “REF 4”); 3GPP TS 36.331 v17.1.0, “E-UTRA, Radio Resource Control (RRC) Protocol Specification” (herein “REF 5”); 3GPP TS 38.211 v17.2.0, “NR, Physical channels and modulation” (herein “REF 6”); 3GPP TS 38.212 v17.2.0, “NR, Multiplexing and Channel coding” (herein “REF 7”); 3GPP TS 38.213 v17.2.0, “NR, Physical Layer Procedures for Control” (herein “REF 8”); 3GPP TS 38.214 v17.2.0, “NR, Physical Layer Procedures for Data” (herein “REF 9”); 3GPP TS 38.215 v17.1.0, “NR, Physical Layer Measurements” (herein “REF 10”); 3GPP TS 38.321 v17.1.0, “NR, Medium Access Control (MAC) protocol specification” (herein “REF 11”); 3GPP TS 38.331 v17.1.0, “NR, Radio Resource Control (RRC) Protocol Specification” (herein “REF 12”).

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for supporting CSI reporting in multi-TRP operations. In certain embodiments, one or more of the BSs 101-103 include circuitry, programing, or a combination thereof for supporting CSI reporting in multi-TRP operations.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

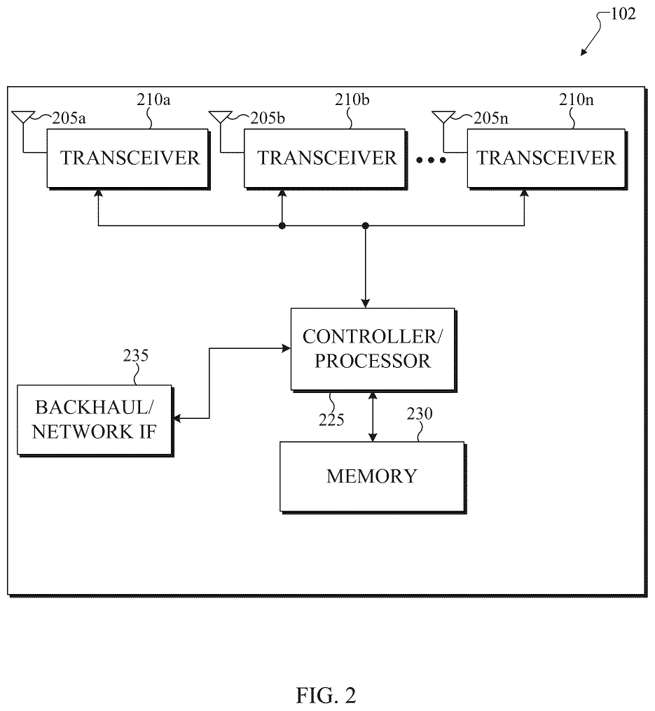

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for supporting CSI reporting in multi-TRP operations. Any of a wide variety of other functions could be supported in the gNB 102 by the controller/processor 225.

The controller/processor 225 is also capable of executing programs and other processes resident in the memory 230, such as processes for supporting CSI reporting in multi-TRP operations. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

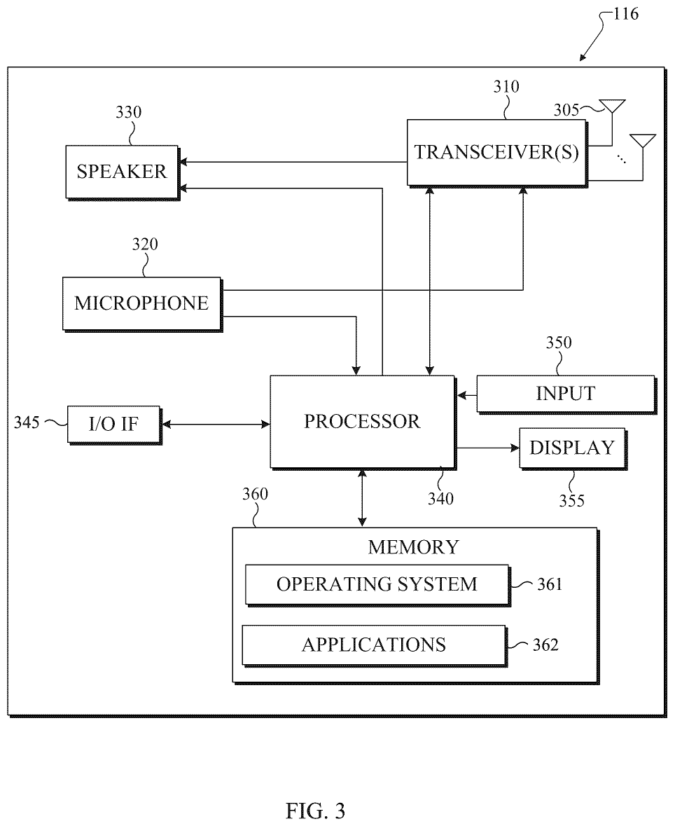

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for supporting CSI reporting in multi-TRP operations. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

The 3GPP NR specification supports up to 32 CSI-RS antenna ports which enable a gNB to be equipped with a large number of antenna elements (such as 64 or 128). In this case, a plurality of antenna elements is mapped onto one CSI-RS port. For next generation cellular systems such as 5G, the maximum number of CSI-RS ports can either remain the same or increase.

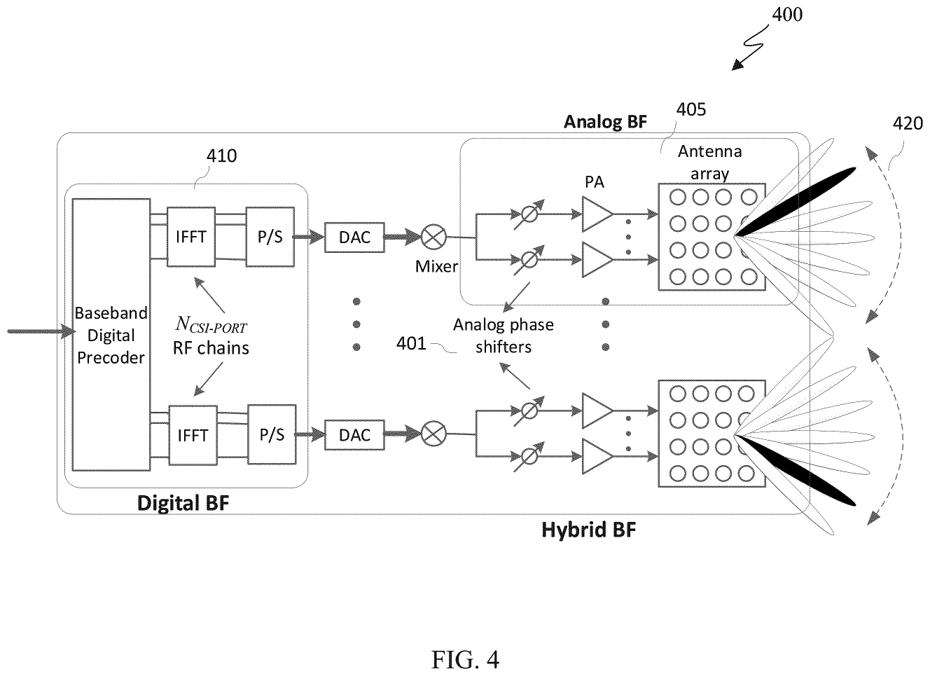

FIG. 4 illustrates an example antenna blocks or arrays 400 according to embodiments of the present disclosure. The embodiment of the antenna blocks or arrays 400 illustrated in FIG. 4 is for illustration only. FIG. 4 does not limit the scope of this disclosure to any particular implementation of the antenna blocks or arrays.

For mmWave bands, although the number of antenna elements can be larger for a given form factor, the number of CSI-RS ports-which can correspond to the number of digitally precoded ports—tends to be limited due to hardware constraints (such as the feasibility to install a large number of ADCs/DACs at mmWave frequencies) as illustrated in FIG. 4. In this case, one CSI-RS port is mapped onto a large number of antenna elements which can be controlled by a bank of analog phase shifters 401. One CSI-RS port can then correspond to one sub-array which produces a narrow analog beam through analog beamforming 405. This analog beam can be configured to sweep across a wider range of angles 420 by varying the phase shifter bank across symbols or subframes. The number of sub-arrays (equal to the number of RF chains) is the same as the number of CSI-RS ports N_{CSI-PORT}. A digital beamforming unit 410 performs a linear combination across N_{CSI-PORT} analog beams to further increase precoding gain. While analog beams are wideband (hence not frequency-selective), digital precoding can be varied across frequency sub-bands or resource blocks. Receiver operation can be conceived analogously.

Since the above system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL transmit (TX) beam (also termed “beam indication”), measuring at least one reference signal for calculating and performing beam reporting (also termed “beam measurement” and “beam reporting”, respectively), and receiving a DL or UL transmission via a selection of a corresponding receive (RX) beam.

The above system is also applicable to higher frequency bands such as >52.6 GHZ (also termed the FR4). In this case, the system can employ only analog beams. Due to the O2 absorption loss around 60 GHz frequency (˜10 dB additional loss @ 100 m distance), larger number of and sharper analog beams (hence larger number of radiators in the array) will be needed to compensate for the additional path loss.

At lower frequency bands such as <1 GHz, on the other hand, the number of antenna elements may not be large in a given form factor due to the large wavelength. As an example, for the case of the wavelength size (A) of the center frequency 600 MHZ (which is 50 cm), it desires 4 m for uniform-linear-array (ULA) antenna panel of 16 antenna elements with the half-wavelength distance between two adjacent antenna elements. Considering a plurality of antenna elements is mapped to one digital port in practical cases, the desirable size for antenna panel(s) at gNB to support a large number of antenna ports such as 32 CSI-RS ports becomes very large in such low frequency bands, and it leads the difficulty of deploying 2-D antenna element arrays within the size of a conventional form factor. This results in a limited number of CSI-RS ports that can be supported at a single site and limits the spectral efficiency of such systems.

Various embodiments of the present disclosure recognize that for a cellular system operating in a sub-1 GHz frequency range (e.g., less than 1 GHZ), supporting large number of CSI-RS antenna ports (e.g., 32) at a single location or remote radio head (RRH) or TRP is challenging due to that a larger antenna form factor size is needed at these frequencies than a system operating at a higher frequency such as 2 GHz or 4 GHz. At such low frequencies, the maximum number of CSI-RS antenna ports that can be co-located at a single site (or TRP/RRH) can be limited, for example to 8. This limits the spectral efficiency of such systems. In particular, the MU-MIMO spatial multiplexing gains offered due to large number of CSI-RS antenna ports (such as 32) can't be achieved.

One way to operate a sub-1 GHz system with large number of CSI-RS antenna ports is based on distributing antenna ports at multiple locations (or TRP/RRHs). The multiple sites or TRPs/RRHs can still be connected to a single (common) base unit, hence the signal transmitted/received via multiple distributed TRPs/RRHs can still be processed at a centralized location. This is called distributed MIMO or multi-TRP coherent joint transmission (C-JT).

Accordingly, various embodiments of the present disclosure consider the multi-TRP C-JT scenario and propose methods and apparatus for CSI reporting in multi-TRP scenarios.

Various embodiments of the present disclosure recognize that CSI enhancement described in Rel-18 MIMO considers Rel-16/17 Type-II CSI codebook refinements to support mTRP coherent joint transmission (C-JT) operations by considering performance-and-overhead trade-off. The Rel-16/17 Type-II CSI codebook has three components W₁, W₂, and W_{f}. CSI coefficients in W₂ across TRPs can have different reference amplitude values due to power imbalance across TRPs. Components for indicating the reference values across TRPs need to be supported in Rel-18.

Accordingly, various embodiments of the present disclosure provide components to indicate reference values for W₂ in addition to components W₁ and W₂ for multi-TRP C-JT scenarios.

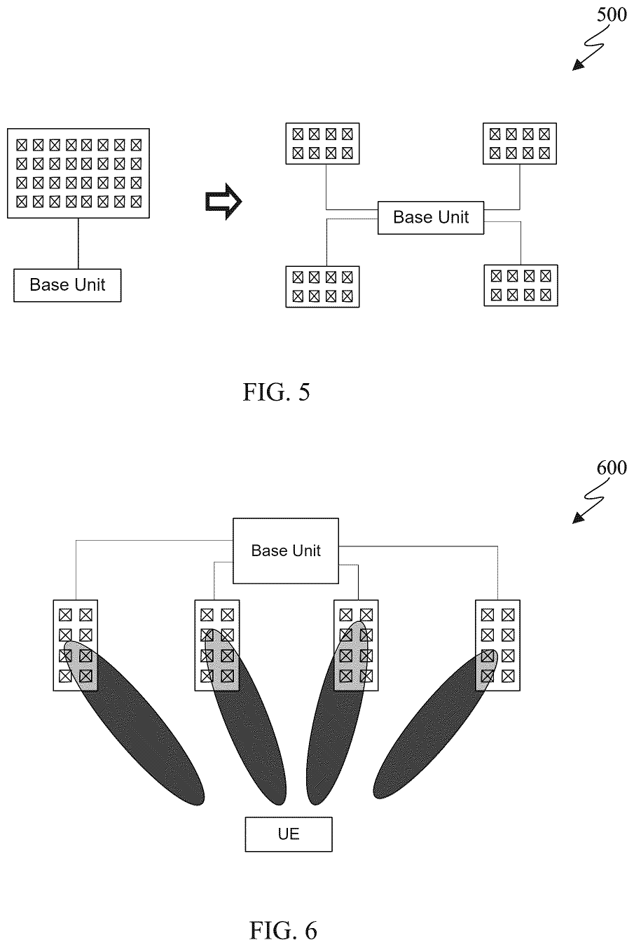

FIG. 5 illustrates an example distributed MIMO system 500 according to embodiments of the present disclosure. The embodiment of the distributed MIMO system 500 illustrated in FIG. 5 is for illustration only. FIG. 5 does not limit the scope of this disclosure to any particular implementation of the distributed MIMO system 500.

One possible approach to resolving the issue is to form multiple TRPs (multi-TRP) or RRHs with a small number of antenna ports instead of integrating all of the antenna ports in a single panel (or at a single site) and to distribute the multiple panels in multiple locations/sites (or TRPs, RRHs). This approach is shown in FIG. 5.

FIG. 6 illustrates an example distributed MIMO system 600 according to embodiments of the present disclosure. The embodiment of the distributed MIMO system 600 illustrated in FIG. 6 is for illustration only. FIG. 6 does not limit the scope of this disclosure to any particular implementation of the distributed MIMO system 600.

As illustrated in FIG. 6, the multiple TRPs at multiple locations can still be connected to a single base unit, and thus the signal transmitted/received via multiple distributed TRPs can be processed in a centralized manner through the single base unit.

Note that although the present disclosure has mentioned low frequency band systems (sub-1 GHz band) as a motivation for distributed MIMO (or mTRP), the distributed MIMO technology is frequency-band-agnostic and can be useful in mid-(sub-6 GHZ) and high-band (above-6 GHZ) systems in addition to low-band (sub-1 GHZ) systems.

The terminology “distributed MIMO” is used as an illustrative purpose, it can be considered under another terminology such as multi-TRP, mTRP, cell-free network, and so on.

All the following components and embodiments are applicable for UL transmission with CP-OFDM (cyclic prefix OFDM) waveform as well as DFT-SOFDM (DFT-spread OFDM) and SC-FDMA (single-carrier FDMA) waveforms. Furthermore, all the following components and embodiments are applicable for UL transmission when the scheduling unit in time is either one subframe (which can consist of one or multiple slots) or one slot.

In the present disclosure, the frequency resolution (reporting granularity) and span (reporting bandwidth) of CSI reporting can be defined in terms of frequency “subbands” and “CSI reporting band” (CRB), respectively.

A subband for CSI reporting is defined as a set of contiguous PRBs which represents the smallest frequency unit for CSI reporting. The number of PRBs in a subband can be fixed for a given value of DL system bandwidth, configured either semi-statically via higher-layer/RRC signaling, or dynamically via L1 DL control signaling or MAC control element (MAC CE). The number of PRBs in a subband can be included in CSI reporting setting.

“CSI reporting band” is defined as a set/collection of subbands, either contiguous or non-contiguous, wherein CSI reporting is performed. For example, CSI reporting band can include all the subbands within the DL system bandwidth. This can also be termed “full-band”. Alternatively, CSI reporting band can include only a collection of subbands within the DL system bandwidth. This can also be termed “partial band”.

The term “CSI reporting band” is used only as an example for representing a function. Other terms such as “CSI reporting subband set” or “CSI reporting bandwidth” can also be used.

In terms of UE configuration, a UE can be configured with at least one CSI reporting band. This configuration can be semi-static (via higher-layer signaling or RRC) or dynamic (via MAC CE or L1 DL control signaling). When configured with multiple (N) CSI reporting bands (e.g., via RRC signaling), a UE can report CSI associated with n≤N CSI reporting bands. For instance, >6 GHz, large system bandwidth may require multiple CSI reporting bands. The value of n can either be configured semi-statically (via higher-layer signaling or RRC) or dynamically (via MAC CE or L1 DL control signaling). Alternatively, the UE can report a recommended value of n via an UL channel.

Therefore, CSI parameter frequency granularity can be defined per CSI reporting band as follows. A CSI parameter is configured with “single” reporting for the CSI reporting band with Mn subbands when one CSI parameter for all the Mn subbands within the CSI reporting band. A CSI parameter is configured with “subband” for the CSI reporting band with Mn subbands when one CSI parameter is reported for each of the Mn subbands within the CSI reporting band.

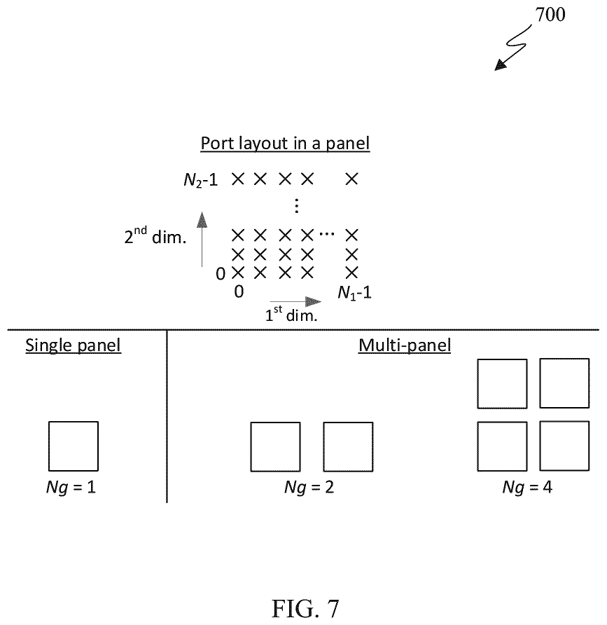

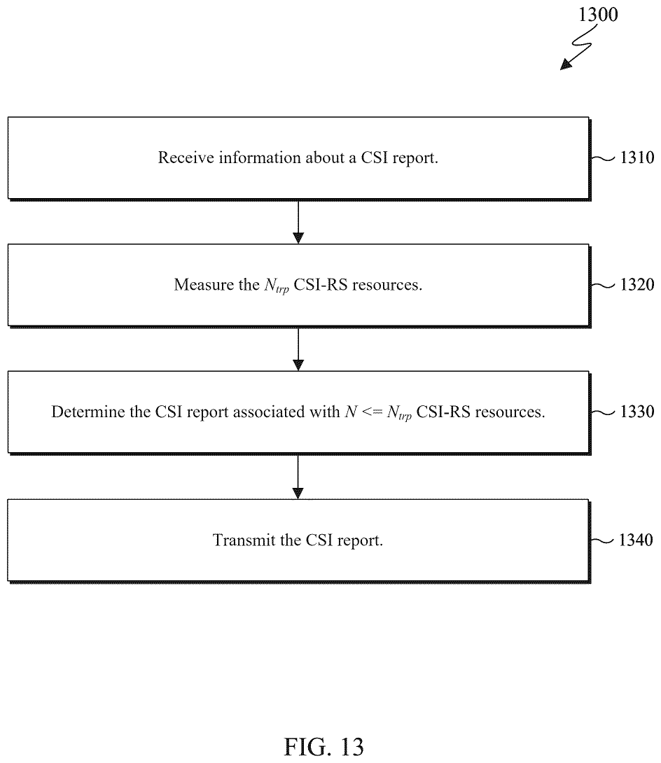

FIG. 7 illustrates an example antenna port layout 700 according to embodiments of the present disclosure. The embodiment of the antenna port layout 700 illustrated in FIG. 13 is for illustration only. FIG. 7 does not limit the scope of this disclosure to any particular implementation of the antenna port layout.

As illustrated in FIG. 7, N₁ and N₂ are the number of antenna ports with the same polarization in the first and second dimensions, respectively. For 2D antenna port layouts, N₁>1, N₂>1, and for 1D antenna port layouts N₁>1 and N₂=1. Therefore, for a dual-polarized antenna port layout, the total number of antenna ports is 2N₁N₂ when each antenna maps to an antenna port. An illustration is shown in FIG. 7 where “X” represents two antenna polarizations. In this disclosure, the term “polarization” refers to a group of antenna ports. For example, antenna ports j=X+0, X+1, . . . ,

$$X + \frac{{P}_{CSIRS}}{2} - 1$$

comprise a first antenna polarization, and antenna ports

$$j = X + \frac{{P}_{CSIRS}}{2} , X + \frac{{P}_{CSIRS}}{2} + 1 , … , X + {P}_{CSIRS} - 1$$

comprise a second antenna polarization, where P_{CSIRS} is a number of CSI-RS antenna ports and X is a starting antenna port number (e.g., X=3000, then antenna ports are 3000, 3001, 3002, . . . ). Let N_{g} be a number of antenna panels at the gNB. When there are multiple antenna panels (N_{g}>1), we assume that each panel is dual-polarized antenna ports with N₁ and N₂ ports in two dimensions. This is illustrated in FIG. 7. Note that the antenna port layouts may or may not be the same in different antenna panels.

In one example, the antenna architecture of a D-MIMO or CJT (coherent joint-transmission) system is structured. For example, the antenna structure at each RRH (or TRP) is dual-polarized (single or multi-panel as shown in FIG. 7. The antenna structure at each RRH/TRP can be the same. Alternatively, the antenna structure at an RRH/TRP can be different from another RRH/TRP. Likewise, the number of ports at each RRH/TRP can be the same. Alternatively, the number of ports at one RRH/TRP can be different from another RRH/TRP. In one example, N_{g}=N_{RRH}, a number of RRHs/TRPs in the D-MIMO transmission.

In another example, the antenna architecture of a D-MIMO or CJT system is unstructured. For example, the antenna structure at one RRH/TRP can be different from another RRH/TRP.

The remainder of the present disclosure assumes a structured antenna architecture. For simplicity, in the remainder of the present disclosure it is assumed that each RRH/TRP is equivalent to a panel, although, an RRH/TRP can have multiple panels in practice. The present disclosure however is not restrictive to a single panel assumption at each RRH/TRP, and can easily be extended (covers) the case when an RRH/TRP has multiple antenna panels.

In one embodiment, an RRH constitutes (or corresponds to or is equivalent to) at least one of the following:
In one example, an RRH corresponds to a TRP.
In one example, an RRH or TRP corresponds to a CSI-RS resource. A UE is configured with K=N_{RRH}>1 non-zero-power (NZP) CSI-RS resources, and a CSI reporting is configured to be across multiple CSI-RS resources. This is similar to Class B, K>1 configuration in Rel. 14 LTE. The K NZP CSI-RS resources can belong to a CSI-RS resource set or multiple CSI-RS resource sets (e.g., K resource sets each comprising one CSI-RS resource). The details are as explained earlier in this disclosure.
In one example, an RRH or TRP corresponds to a CSI-RS resource group, where a group comprises one or multiple NZP CSI-RS resources. A UE is configured with K≥N_{RRH}>1 non-zero-power (NZP) CSI-RS resources, and a CSI reporting is configured to be across multiple CSI-RS resources from resource groups. This is similar to Class B, K>1 configuration in Rel. 14 LTE. The K NZP CSI-RS resources can belong to a CSI-RS resource set or multiple CSI-RS resource sets (e.g., K resource sets each comprising one CSI-RS resource). The details are as explained earlier in this disclosure. In particular, the K CSI-RS resources can be partitioned into N_{RRH} resource groups. The information about the resource grouping can be provided together with the CSI-RS resource setting/configuration, or with the CSI reporting setting/configuration, or with the CSI-RS resource configuration.
In one example, an RRH or TRP corresponds to a subset (or a group) of CSI-RS ports. A UE is configured with at least one NZP CSI-RS resource comprising (or associated with) CSI-RS ports that can be grouped (or partitioned) multiple subsets/groups/parts of antenna ports, each corresponding to (or constituting) an RRH/TRP. The information about the subsets of ports or grouping of ports can be provided together with the CSI-RS resource setting/configuration, or with the CSI reporting setting/configuration, or with the CSI-RS resource configuration.
In one example, an RRH or TRP corresponds to one or more examples described above depending on a configuration. For example, this configuration can be explicit via a parameter (e.g., an RRC parameter). Alternatively, it can be implicit.
   In one example, when implicit, it could be based on the value of K. For example, when K>1 CSI-RS resources, an RRH corresponds to one or more examples described above, and when K=1 CSI-RS resource, an RRH corresponds to one or more examples described above.
   In another example, the configuration could be based on the configured codebook. For example, an RRH corresponds to a CSI-RS resource or resource group when the codebook corresponds to a decoupled codebook (modular or separate codebook for each RRH), and an RRH corresponds to a subset (or a group) of CSI-RS ports when codebook corresponds to a coupled (joint or coherent) codebook (one joint codebook across TRPs/RRHs).

In one example, when RRH or TRP maps (or corresponds to) a CSI-RS resource or resource group, and a UE can select a subset of RRHs (resources or resource groups) and report the CSI for the selected TRPs/RRHs (resources or resource groups), the selected TRPs/RRHs can be reported via an indicator. For example, the indicator can be a CRI or a PMI (component) or a new indicator.

In one example, when RRH or TRP maps (or corresponds to) a CSI-RS port group, and a UE can select a subset of TRPs/RRHs (port groups) and report the CSI for the selected TRPs/RRHs (port groups), the selected TRPs/RRHs can be reported via an indicator. For example, the indicator can be a CRI or a PMI (component) or a new indicator.

In one example, when multiple (K>1) CSI-RS resources are configured for N_{RRH} TRPs/RRHs, a decoupled (modular) codebook is used/configured, and when a single (K=1) CSI-RS resource for N_{RRH} TRPs/RRHs, a joint codebook is used/configured.

As described in U.S. Pat. No. 10,659,118, issued May 19, 2020, and entitled “Method and Apparatus for Explicit CSI Reporting in Advanced Wireless Communication Systems,” which is incorporated herein by reference in its entirety, a UE is configured with high-resolution (e.g., Type II) CSI reporting in which the linear combination-based Type II CSI reporting framework is extended to include a frequency dimension in addition to the first and second antenna port dimensions.

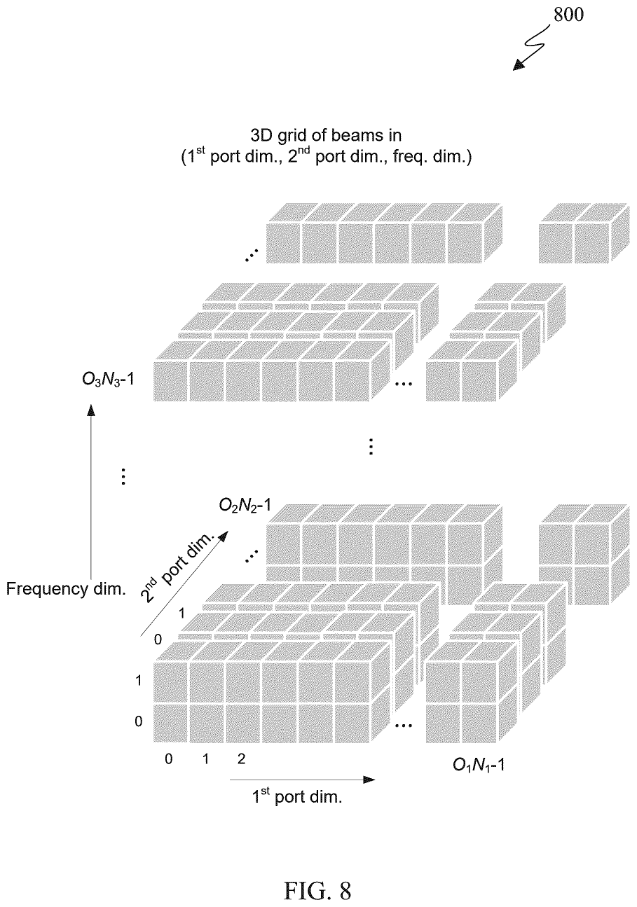

FIG. 8 illustrates a 3D grid of oversampled DFT beams 800 according to embodiments of the present disclosure. The embodiment of the 3D grid of oversampled DFT beams 800 illustrated in FIG. 8 is for illustration only. FIG. 8 does not limit the scope of this disclosure to any particular implementation of the 3D grid of oversampled DFT beams.

As illustrated, FIG. 8 shows a 3D grid 800 of the oversampled DFT beams (1st port dim., 2nd port dim., freq. dim.) in which
a 1st dimension is associated with the 1st port dimension,
a 2nd dimension is associated with the 2nd port dimension, and
a 3rd dimension is associated with the frequency dimension.

The basis sets for 1^{st} and 2^{nd} port domain representation are oversampled DFT codebooks of length-N₁ and length-N₂, respectively, and with oversampling factors O₁ and O₂, respectively. Likewise, the basis set for frequency domain representation (i.e., 3rd dimension) is an oversampled DFT codebook of length-N₃ and with oversampling factor O₃. In one example, O₁=O₂=O₃=4. In one example, O₁=O₂=4 and O₃=1. In another example, the oversampling factors O; belongs to {2, 4, 8}. In yet another example, at least one of O₁, O₂, and O₃ is higher layer configured (via RRC signaling).

As explained in Section 5.2.2.2.6 of REF9, a UE is configured with higher layer parameter codebookType set to ‘typeII-PortSelection-r16’ for an enhanced Type II CSI reporting in which the pre-coders for all SBs and for a given layer l=1, . . . , v, where v is the associated RI value, is given by either

$$( Eq . 1 )$$

$${W}^{l} = {AC}_{l} {B}^{H} = {[ {a}_{0} {a}_{1} … {a}_{L - 1} ] [ \begin{matrix}{c}_{l , 0 , 0} & {c}_{l , 0 , 1} & … & {c}_{l , 0 , M - 1} \\ {c}_{l , 1 , 0} & {c}_{l , 1 , 1} & … & {c}_{l , 1 , M - 1} \\ ⋮ & ⋮ & ⋮ & ⋮ \\ {c}_{l , L - 1 , 0} & {c}_{l , L - 1 , 1} & … & {c}_{l , L - 1 , M - 1}\end{matrix} ] [ {b}_{0} {b}_{1} … {b}_{M - 1} ]}^{H} = {\sum }_{f = 0}^{M - 1} {\sum }_{i = 0}^{L - 1} {c}_{l , i , f} ( {a}_{i} {b}_{f}^{H} ) = {\sum }_{i = 0}^{L - 1} {\sum }_{f = 0}^{M - 1} {c}_{l , i , f} ( {a}_{i} {b}_{f}^{H} ) ,$$

$$or$$

$$( Eq . 2 )$$

$${W}^{l} = [ \begin{matrix}A & 0 \\ 0 & A\end{matrix} ] {C}_{l} \text{} {B}^{H} = [ \begin{matrix}{a}_{0} {a}_{1} … {a}_{L - 1} & 0 \\ 0 & {a}_{0} {a}_{1} … {a}_{L - 1}\end{matrix} ] [ \begin{matrix}{c}_{l , 0 , 0} & {c}_{l , 0 , 1} & … & {c}_{l , 0 , M - 1} \\ {c}_{l , 1 , 0} & {c}_{l , 1 , 1} & … & {c}_{l , 1 , M - 1} \\ ⋮ & ⋮ & ⋮ & ⋮ \\ {c}_{l , L - 1 , 0} & {c}_{l , L - 1 , 1} & … & {c}_{l , L - 1 , M - 1}\end{matrix} ] {[ {b}_{0} {b}_{1} … {b}_{M - 1} ]}^{H} = [ \begin{matrix}{\sum }_{f = 0}^{M - 1} {\sum }_{i = 0}^{L - 1} {c}_{l , i , f} ( {a}_{i} {b}_{f}^{H} ) \\ {\sum }_{f = 0}^{M - 1} {\sum }_{i = 0}^{L - 1} {c}_{l , i + L , f} ( {a}_{i} {b}_{f}^{H} )\end{matrix} ] ,$$

where:
N₁ is a number of antenna ports in a first antenna port dimension (having the same antenna polarization),
N₂ is a number of antenna ports in a second antenna port dimension (having the same antenna polarization),
P_{CSI-RS} is a number of CSI-RS ports configured to the UE,
N₃ is a number of SBs for PMI reporting or number of FD units or number of FD components (that comprise the CSI reporting band) or a total number of precoding matrices indicated by the PMI (one for each FD unit/component),
aᵢ is a 2N₁N₂×1 (Eq. 1) or N₁N₂×1 (Eq. 2) column vector, or aᵢ is a P_{CSIRS}×1 (Eq. 1) or

$$\frac{{P}_{CSIRS}}{2} \times 1$$

port selection column vector, where a port selection vector is a defined as a vector which contains a value of 1 in one element and zeros elsewhere,
b_{f} is a N₃×1 column vector,
c_{l,i,f} is a complex coefficient.

In a variation, when the UE reports a subset K<2 LM coefficients (where K is either fixed, configured by the gNB or reported by the UE), then the coefficient c_{l,i,f} in precoder equations Eq. 1 or Eq. 2 is replaced with x_{l,i,f}×C_{l,i,f}, where
x_{l,i,f}=1 if the coefficient c_{l,i,f} is reported by the UE according to some embodiments of this disclosure.
X_{l,i,f}=0 otherwise (i.e., c_{l,i,f} is not reported by the UE).

The indication whether x_{l,i,f}=1 or 0 is according to some embodiments of this disclosure. For example, it can be via a bitmap.

In a variation, the precoder equations Eq. 1 or Eq. 2 are respectively generalized to

$${W}^{l} = {\sum }_{i = 0}^{L - 1} {\sum }_{f = 0}^{{M}_{i} - 1} {c}_{l , i , f} ( {a}_{i} {b}_{i , f}^{H} ) \qquad ( Eq . 3 )$$

$$and$$

$${W}^{l} = [ \begin{matrix}{\sum }_{i = 0}^{L - 1} {\sum }_{f = 0}^{{M}_{i} - 1} {c}_{l , i , f} ( {a}_{i} {b}_{i , f}^{H} ) \\ {\sum }_{i = 0}^{L - 1} {\sum }_{= 0}^{{M}_{i} - 1} {c}_{l , i + L , f} ( {a}_{i} {b}_{i , f}^{H} )\end{matrix} ] , \qquad ( Eq . 4 )$$

where for a given i, the number of basis vectors is Mᵢ and the corresponding basis vectors are {b_{i,f}}. Note that Mᵢ is the number of coefficients c_{l,i,f} reported by the UE for a given i, where Mᵢ≤M (where {Mᵢ} or ΣMᵢ is either fixed, configured by the gNB or reported by the UE).

The columns of W^{l} are normalized to norm one. For rank R or R layers (v=R), the pre-coding matrix is given by

$${W}^{( R )} = \frac{1}{\sqrt{R}} [ \begin{matrix}{W}^{1} & {W}^{2} & … & {W}^{R}\end{matrix} ] .$$

Eq. 2 is assumed in the rest of the disclosure. The embodiments of the disclosure, however, are general and are also application to Eq. 1, Eq. 3 and Eq. 4.

Here

$$L \leq \frac{{P}_{CSI - RS}}{2} and M \leq {N}_{3} . If L = \frac{{P}_{CSI - RS}}{2} ,$$

then A is an identity matrix, and hence not reported. Likewise, if M=N₃, then B is an identity matrix, and hence not reported. Assuming M<N₃, in an example, to report columns of B, the oversampled DFT codebook is used. For instance, b_{f}=W_{f}, where the quantity w_{f} is given by

$${w}_{f} = [ \begin{matrix}1 & {e}^{j \frac{2 π {n}_{3 , l}^{( f )}}{{O}_{3} {N}_{3}}} & {e}^{j \frac{2 π \text{.2} {n}_{3 , l}^{( f )}}{{O}_{3} {N}_{3}}} & {e}^{{j \frac{2 π . ( {N}_{3} - 1 ) {n}_{3 , l}^{( f )}}{{O}_{3} {N}_{3}} ]}^{T}}\end{matrix} .$$

When O₃=1, the FD basis vector for layer l∈{1, . . . , v} (where v is the RI or rank value) is given by

$${w}_{f} = {[ \begin{matrix}{y}_{0 , l}^{( f )} & {y}_{1 , l}^{( f )} & … & {y}_{{N}_{3} - 1 , l}^{( f )}\end{matrix} ]}^{T} ,$$

where

$${y}_{t , l}^{( f )} = {e}^{j \frac{2 π {tn}_{3 , l}^{( f )}}{{N}_{3}}} and {n}_{3 , l} = [ {n}_{3 , l}^{( 0 )} , … , {n}_{3 , l}^{( M - 1 )} ] where$$

$${n}_{3 , l}^{( f )} ∈ \{ 0 , 1 , … , {N}_{3} - 1 \} .$$

In another example, discrete cosine transform DCT basis is used to construct/report basis B for the 3^{rd} dimension. The m-th column of the DCT compression matrix is simply given by

$${[ {W}_{f} ]}_{nm} = \{ \begin{matrix}\frac{1}{\sqrt{K}} , n = 0 \\ \sqrt{\frac{2}{K}} cos \frac{π ( 2 m + 1 ) n}{2 K} , n = 1 , … K - 1\end{matrix} , and K = {N}_{3} ,$$

$$and m = 0 , … , {N}_{3} - 1.$$

Since DCT is applied to real valued coefficients, the DCT is applied to the real and imaginary components (of the channel or channel eigenvectors) separately. Alternatively, the DCT is applied to the magnitude and phase components (of the channel or channel eigenvectors) separately. The use of DFT or DCT basis is for illustration purpose only. The disclosure is applicable to any other basis vectors to construct/report A and B.

On a high level, a precoder W^{l} can be described as follows.

$$W = {A}_{l} {C}_{l} {B}_{l}^{H} = {W}_{1} {\tilde{W}}_{2} {W}_{f}^{H} , \qquad ( Eq . 5 )$$

where A=W₁ corresponds to the Rel. 15 W₁ in Type II CSI codebook [REF9], and B=W_{f}.

The Cₗ=\tilde{W}₂ matrix consists of all the required linear combination coefficients (e.g., amplitude and phase or real or imaginary). Each reported coefficient (c_{l,i,f}=p_{l,i,f}ϕ_{l,i,f}) in \tilde{W}₂ is quantized as amplitude coefficient (p_{l,i,f}) and phase coefficient (φ_{l,i,f}). In one example, the amplitude coefficient (p_{l,i,f}) is reported using a A-bit amplitude codebook where A belongs to {2, 3, 4}. If multiple values for A are supported, then one value is configured via higher layer signaling. In another example, the amplitude coefficient (p_{l,i,f}) is reported as

$${p}_{l , i , f} = {p}_{l , i , f}^{( 1 )} {p}_{l , i , f}^{( 2 )}$$

where

$${p}_{l , i , f}^{( 1 )}$$

is a reference or first amplitude which is reported using an A1-bit amplitude codebook where A1 belongs to {2, 3, 4}, and

$${p}_{l , i , f}^{( 2 )}$$

is a differential or second amplitude which is reported using a A2-bit amplitude codebook where A2≤A1 belongs to {2, 3, 4}.

For layer l, let us denote the linear combination (LC) coefficient associated with spatial domain (SD) basis vector (or beam) i∈{0,1, . . . , 2L−1} and frequency domain (FD) basis vector (or beam) f∈{0,1, . . . , M−1} as c_{l,i,f}, and the strongest coefficient as c_{l,i*,f*}. The strongest coefficient is reported out of the K_{NZ} non-zero (NZ) coefficients that is reported using a bitmap, where K_{NZ}≤K₀=[β×2 LM]<2 LM and β is higher layer configured. The remaining 2 LM−K_{NZ} coefficients that are not reported by the UE are assumed to be zero. The following quantization scheme is used to quantize/report the K_{NZ} NZ coefficients.
UE reports the following for the quantization of the NZ coefficients in \tilde{W}₂
   A X-bit indicator for the strongest coefficient index (i*, f*), where X=┌log₂ K_{NZ}┐ or ┌log₂ 2L┐.
      i. Strongest coefficient cui f*=1 (hence its amplitude/phase are not reported)
   Two antenna polarization-specific reference amplitudes is used.
      i. For the polarization associated with the strongest coefficient c_{l,i*,f}+=1, since the reference amplitude

$${p}_{l , i , f}^{( 1 )} = 1 ,$$

it is not reported
   ii. For the other polarization, reference amplitude

$${p}_{l , i , f}^{( 1 )}$$

is quantized to 4 bits.
   1. The 4-bit amplitude alphabet is

$$\{ 1 , {( \frac{1}{2} )}^{\frac{1}{4}} , {( \frac{1}{4} )}^{\frac{1}{4}} , {( \frac{1}{8} )}^{\frac{1}{4}} , … , {( \frac{1}{{2}^{14}} )}^{\frac{1}{4}} \} .$$

For {c_{l,i,f}, (i, f)≠(i*, f*)}:
   i. For each polarization, differential amplitudes

$${p}_{l , i , f}^{( 2 )}$$

of the coefficients calculated relative to the associated polarization-specific reference amplitude and quantized to 3 bits.
   1. The 3-bit amplitude alphabet is

$$\{ 1 , \frac{1}{\sqrt{2}} , \frac{1}{2} , \frac{1}{2 \sqrt{2}} , \frac{1}{4} , \frac{1}{4 \sqrt{2}} , \frac{1}{8} , \frac{1}{8 \sqrt{2}} \} .$$

2. Note: The final quantized amplitude p_{l,i,f} is given by

$${p}_{l , i , f}^{( 1 )} \times {p}_{l , i , f}^{( 2 )}$$

ii. Each phase is quantized to either 8PSK (Nₚₕ=8) or 16PSK (Nₚₕ=16) (which is configurable).

For the polarization r*∈{0,1} associated with the strongest coefficient c_{l,i*,f*}, we have

$${r}^{*} = ⌊ \frac{{i}^{*}}{L} ⌋$$

and the reference amplitude

$${p}_{l , i , f}^{( 1 )} = {p}_{l , {r}^{*}}^{( 1 )} = 1.$$

For the other polarization r∈{0,1} and r≠r*, we have

$$r = ( ⌊ \frac{{i}^{*}}{L} ⌋ + 1 )$$

mod 2 and the reference amplitude

$${p}_{l , i , f}^{( 1 )} = {p}_{l , r}^{( 1 )}$$

is quantized (reported) using the 4-bit amplitude codebook mentioned above.

In Rel. 16 enhanced Type II and Type II port selection codebooks, a UE can be configured to report M FD basis vectors. In one example,

$$M = ⌈ p \times \frac{{N}_{3}}{R} ⌉ ,$$

where R is higher-layer configured from {1,2} and p is higher-layer configured from

$$\{ \frac{1}{4} , \frac{1}{2} \} .$$

in one example, the p value is higher-layer configured for rank 1-2 CSI reporting. For rank>2 (e.g., rank 3-4), the p value (denoted by v₀) can be different. In one example, for rank 1-4, (p, v₀) is jointly configured from

$$\{ ( \frac{1}{2} , \frac{1}{4} ) , ( \frac{1}{4} , \frac{1}{4} ) , ( \frac{1}{4} , \frac{1}{8} ) \} , i . e . , M = ⌈ p \times \frac{{N}_{3}}{R} ⌉$$

for rank 1-2 and

$$M = ⌈ {v}_{0} \times \frac{{N}_{3}}{R} ⌉$$

for rank 3-4. In one example, N₃=N_{SB}×R where N_{SB} is the number of SBs for CQI reporting. In one example, M is replaced with Mᵥ to show its dependence on the rank value v, hence p is replaced with pᵥ, v∈{1,2} and v₀ is replaced with pᵥ, v∈{3,4}.

A UE can be configured to report Mᵥ FD basis vectors in one-step from N₃ basis vectors freely (independently) for each layer l∈{1, . . . , v} of a rank v CSI reporting. Alternatively, a UE can be configured to report My FD basis vectors in two-step as follows.
In step 1, an intermediate set (InS) comprising

$${N}_{3}^{′} < {N}_{3}$$

basis vectors is selected/reported wherein the InS is common for all layers.
In step 2, for each layer l∈{1, . . . , v} of a rank v CSI reporting, Mᵥ FD basis vectors are selected/reported freely (independently) from

$${N}_{3}^{′}$$

basis vectors in the Ins.

In one example, one-step method is used when N₃≤19 and two-step method is used when N₃>19. In one example,

$${N}_{3}^{′} = ⌈ α {M}_{υ} ⌉$$

where α>1 is either fixed (to 2 for example) or configurable.

The codebook parameters used in the DFT based frequency domain compression (Eq. 5) are (L, pᵥ for v∈{1,2}, pᵥ for v∈{3,4}, β, α, Nₚₕ). The set of values for these codebook parameters are as follows.
L: the set of values is {2,4} in general, except L∈{2,4,6} for rank 1-2, 32 CSI-RS antenna ports, and R=1.

$$( {p}_{υ} for υ ∈ \{ 1 , 2 \} , {p}_{υ} for υ ∈ \{ 3 , 4 \} ∈ \{ ( \frac{1}{2} , \frac{1}{4} ) , ( \frac{1}{4} , \frac{1}{4} ) , ( \frac{1}{4} , \frac{1}{8} ) \} .$$

$$β ∈ \{ \frac{1}{4} , \frac{1}{2} , \frac{3}{4} \} .$$

$$α = 2$$

$${N}_{p h} = 16 .$$

The set of values for these codebook parameters are as in Table 1.

TABLE 1

| | | p_{υ} | | |
|---|---|---|---|---|
| paramCombination | L | υ ∈ {1, 2} | υ ∈ {3, 4} | β |
| 1 | 2 | ¼ | ⅛ | ¼ |
| 2 | 2 | ¼ | ⅛ | ½ |
| 3 | 4 | ¼ | ⅛ | ¼ |
| 4 | 4 | ¼ | ⅛ | ½ |
| 5 | 4 | ¼ | ¼ | ¾ |
| 6 | 4 | ½ | ¼ | ½ |
| 7 | 6 | ¼ | — | ½ |
| 8 | 6 | ¼ | — | ¾ |

In Rel. 17 (further enhanced Type II port selecting codebook), M∈{1,2},

$$L = \frac{{K}_{1}}{2}$$

where K₁=α×P_{CSIRS}, and codebook parameters (M, α, β) are configured from Table 2.

TABLE 2

| paramCombination-r17 | M | α | β |
|---|---|---|---|
| 1 | 1 | ¾ | ½ |
| 2 | 1 | 1 | ½ |
| 3 | 1 | 1 | ¾ |
| 4 | 1 | 1 | 1 |
| 5 | 2 | ½ | ½ |
| 6 | 2 | ¾ | ½ |
| 7 | 2 | 1 | ½ |
| 8 | 2 | 1 | ¾ |

The above-mentioned framework (Eq. 5) represents the precoding-matrices for multiple (N₃) FD units using a linear combination (double sum) over 2 L (or K₁) SD beams/ports and Mᵥ FD beams. This framework can also be used to represent the precoding-matrices in time domain (TD) by replacing the FD basis matrix W_{f} with a TD basis matrix Wₜ, wherein the columns of Wₜ comprises Mᵥ TD beams that represent some form of delays or channel tap locations. Hence, a precoder W^{l} can be described as follows.

$$W = {A}_{l} {C}_{l} {B}_{l}^{H} = {W}_{1} {\tilde{W}}_{2} {W}_{t}^{H} , \qquad ( Eq . 5 A )$$

In one example, the Mᵥ TD beams (representing delays or channel tap locations) are selected from a set of N₃ TD beams, i.e., N₃ corresponds to the maximum number of TD units, where each TD unit corresponds to a delay or channel tap location. In one example, a TD beam corresponds to a single delay or channel tap location. In another example, a TD beam corresponds to multiple delays or channel tap locations. In another example, a TD beam corresponds to a combination of multiple delays or channel tap locations.

In one example, the codebook for the CSI report is according to at least one of the following examples.
In one example, the codebook can be a Rel. 15 Type I single-panel codebook (cf. 5.2.2.2.1, TS 38.214).
In one example, the codebook can be a Rel. 15 Type I multi-panel codebook (cf. 5.2.2.2.2, TS 38.214).
In one example, the codebook can be a Rel. 15 Type II codebook (cf. 5.2.2.2.3, TS 38.214).
In one example, the codebook can be a Rel. 15 port selection Type II codebook (cf. 5.2.2.2.4, TS 38.214).
In one example, the codebook can be a Rel. 16 enhanced Type II codebook (cf. 5.2.2.2.5, TS 38.214).
In one example, the codebook can be a Rel. 16 enhanced port selection Type II codebook (cf. 5.2.2.2.6, TS 38.214).
In one example, the codebook can be a Rel. 17 further enhanced port selection Type II codebook (cf. 5.2.2.2.7, TS 38.214).
In one example, the codebook is a new codebook for C-JT CSI reporting.
   In one example, the new codebook is a decoupled codebook comprising the following components:
      Intra-TRP: per TRP Rel. 16/17 Type II codebook components, i.e., SD basis vectors (W1), FD basis vectors (Wf), W2 components (e.g., SCI, indices of NZ coefficients, and amplitude/phase of NZ coefficients).
      Inter-TRP: co-amplitude and co-phase for each TRP.
   In one example, the new codebook is a joint codebook comprising the following components
      Per TRP SD basis vectors (W₁)
      Single joint FD basis vectors (Wf)
      Single joint W2 components (e.g., SCI, indices of NZ coefficients, and amplitude/phase of NZ coefficients)

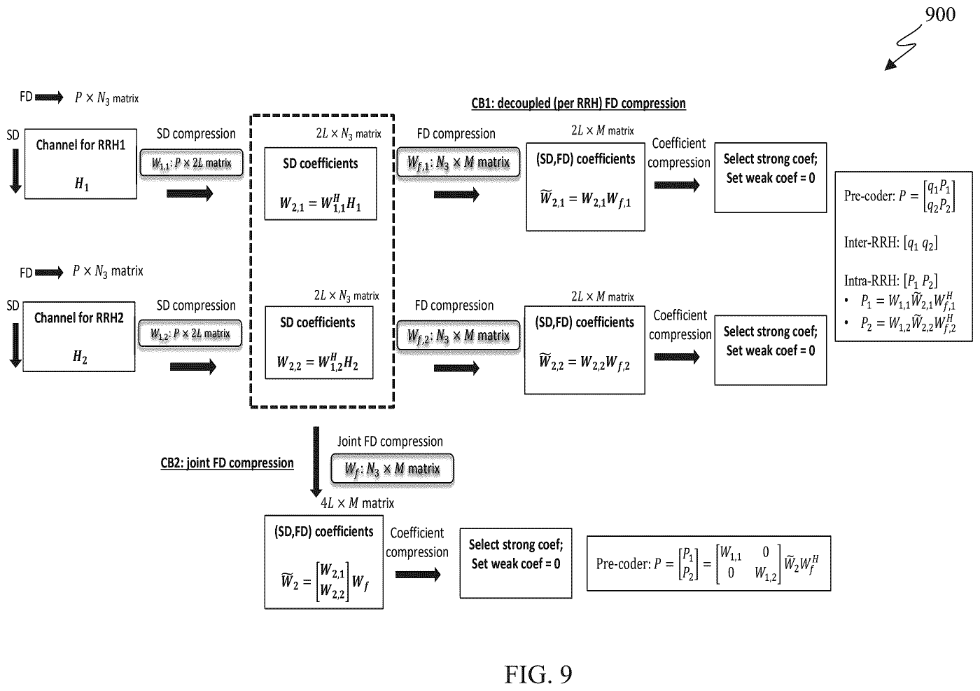

FIG. 9 illustrates two new codebooks 900 according to embodiments of the present disclosure. The embodiment of the two new codebooks 900 illustrated in FIG. 9 is for illustration only. FIG. 9 does not limit the scope of this disclosure to any particular implementation of the two new codebooks 900.

In one example, when the codebook is a legacy codebook (e.g., one of Rel. 15/16/17 NR codebooks, according to one of the examples above), then the CSI reporting is based on a CSI resource set comprising one or multiple NZP CSI-RS resource(s), where each NZP CSI-RS resource comprises CSI-RS antenna ports for all TRPs/RRHs, i.e.,

$$P = {\sum }_{r = 1}^{N} {P}_{r} ,$$

where P is the total number of antenna ports, and Pᵣ is the number of antenna ports associated with r-th TRP. In this case, a TRP corresponds to (or maps to or is associated with) a group of antenna ports.

In one example, when the codebook is a new codebook (e.g., one of the two new codebooks above), then the CSI reporting is based on a CSI resource set comprising one or multiple NZP CSI-RS resource(s).
In one example, each NZP CSI-RS resource comprises CSI-RS antenna ports for all TRPs/RRHs. i.e.

$$P = {\sum }_{r = 1}^{N} {P}_{r} ,$$

where P is the total number of antenna ports, and Pᵣ is the number of antenna ports associated with r-th TRP. In this case, a TRP corresponds to (or maps to or is associated with) a group of antenna ports.
In one example, each NZP CSI-RS resource corresponds to (or maps to or is associated with) a TRP/RRH.

In the present disclosure, we use N, N_{TRP}, N_{RRH} interchangeably for a number of TRPs/RRHs.

In one embodiment, a UE is configured with an mTRP (or D-MIMO or C-JT) codebook, via e.g., higher layer parameter codebookType set to ‘typeII-r18-cjt’, which is designed based on Rel-16/17 Type-II codebook. For example, The mTRP codebook has a triple-stage structure which can be represented as

$$W = {W}_{1} {W}_{2} {W}_{f}^{H} ,$$

where the component W₁ is used to report/indicate a spatial-domain (SD) basis matrix comprising SD basis vectors, the component W_{f} is used to report/indicate a frequency-domain (FD) basis matrix comprising FD basis vectors, and the component W₂ is used to report/indicate coefficients corresponding to SD and FD basis vectors.

The disclosures of beam selection described below for W₁ is not only for SD beam selection, (e.g., DFT basis vector selection) but also for port selection, (e.g., vᵢ selection where vᵢ is a vector having 1 for the i-th element and 0 elsewhere.) Port selection and beam selection can be interchangeable when appropriate.

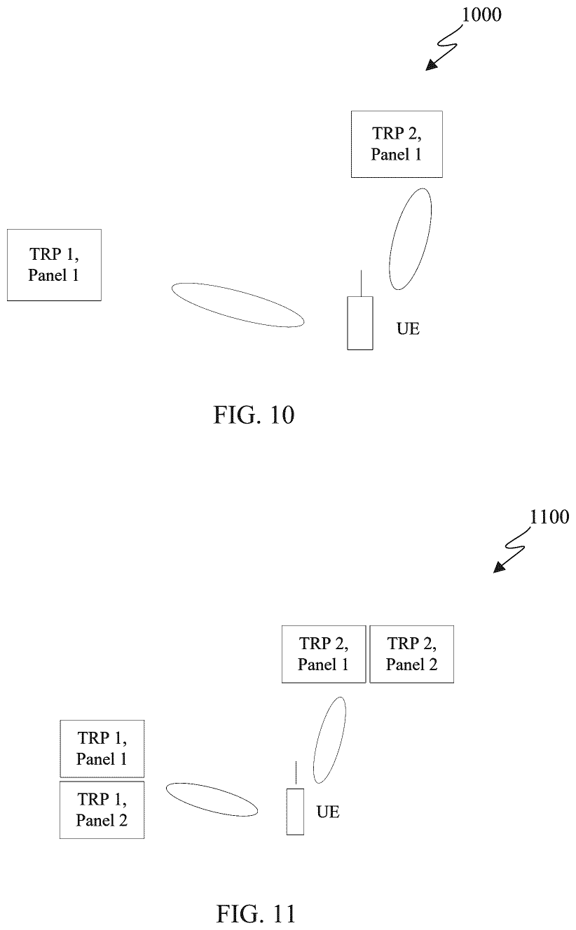

FIG. 10 illustrates an example distributed MIMO system 1000 where each TRP has a single antenna panel according to embodiments of the present disclosure. The embodiment of the distributed MIMO system 1000 where each TRP has a single antenna panel illustrated in FIG. 10 is for illustration only. FIG. 10 does not limit the scope of this disclosure to any particular implementation of the distributed MIMO system 1000 where each TRP has a single antenna panel.

As illustrated in FIG. 10, in one embodiment, each TRP has a single antenna panel. The component W₁ has a block diagonal structure comprising X diagonal blocks, where 1 (co-pol) or 2 (dual-pol) diagonal blocks are associated with each TRP.

In one example, X=N_{TRP} assuming co-polarized (single polarized) antenna structure at each TRP. In one example, when N_{TRP}=2, the components W₁ is given by

$${W}_{1} = [ \begin{matrix}{B}_{1} & 0 \\ 0 & {B}_{2}\end{matrix} ]$$

where B₁ is a basis matrix for the 1^{st} TRP, and B₂ is a basis matrix for the 2^{nd} TRP. In one example, Bᵣ=[b_{r,0}, b_{r,1}, . . . , b_{r, L}_{ᵣ}₋₁] comprises Lᵣ columns or beams (or basis vectors) for r-th TRP. In one example, Lᵣ=L for all r values (TRP-common L value), for example, L∈{2,3,4,6}. In one example, Lᵣ can be different across TRPs (TRP-specific L value), for example, Lᵣ can take a value (fixed or configured) from {2,3,4,6}.

In one example, X=2N_{TRP} assuming dual-polarized (cross-polarized) antenna structure at each TRP.

In one example, when N_{TRP}=2, the components W₁ is given by

$${W}_{1} = [ \begin{matrix}{B}_{1} & 0 & 0 & 0 \\ 0 & {B}_{1} & 0 & 0 \\ 0 & 0 & {B}_{2} & 0 \\ 0 & 0 & 0 & {B}_{2}\end{matrix} ]$$

where B₁ is a basis matrix for the 1^{st} TRP and is common (the same) for the two polarizations, which correspond to the first and second diagonal blocks, and B₂ is a basis matrix for the 2^{nd} TRP and is common (the same) for the two polarizations, which correspond to the third and fourth diagonal blocks. In general, (2r−1)-th and (2r)-th diagonal blocks correspond to the two antenna polarizations for the r-th TRP. In one example, Bᵣ=[b_{r,0}, b_{r,1}, . . . , b_{r, L}_{ᵣ}₋₁] comprises Lᵣ columns or beams (or basis vectors) for r-th TRP. In one example, Lᵣ=L for all r values (TRP-common L value), for example, L∈{2,3,4,6}. In one example, Lᵣ can be different across TRPs (TRP-specific L value), for example, Lᵣ can take a value (fixed or configured) from {2,3,4,6}.

In one example, when N_{TRP}=2, the components W₁ is given by

$${W}_{1} = [ \begin{matrix}{B}_{1} & 0 & 0 & 0 \\ 0 & {B}_{2} & 0 & 0 \\ 0 & 0 & {B}_{1} & 0 \\ 0 & 0 & 0 & {B}_{2}\end{matrix} ]$$

where B₁ is a basis matrix for the 1^{st} TRP and is common (the same) for the two polarizations, which correspond to the first and third diagonal blocks, and B₂ is a basis matrix for the 2^{nd} TRP and is common (the same) for the two polarizations, which correspond to the second and fourth diagonal blocks. In general, r-th and (r+N_{TRP})-th diagonal blocks correspond to the two antenna polarizations for the r-th TRP. In one example, Bᵣ=[b_{r,0}, b_{r,1}, . . . , b_{r,L}_{ᵣ}₋₁] comprises Lᵣ columns or beams (or basis vectors) for r-th TRP. In one example, L=L for all r values (TRP-common L value), for example, L∈{2,3,4,6}. In one example, L, can be different across TRPs (TRP-specific L value), for example, L, can take a value (fixed or configured) from {2,3,4,6}.

In one example, when N_{TRP}=2, the components W₁ is given by

$${W}_{1} = [ \begin{matrix}{B}_{1 , 1} & 0 & 0 & 0 \\ 0 & {B}_{1 , 2} & 0 & 0 \\ 0 & 0 & {B}_{2 , 1} & 0 \\ 0 & 0 & 0 & {B}_{2 , 2}\end{matrix} ]$$

where B_{1,1} and B_{1,2} are basis matrices for the first and second antenna polarizations of the 1^{st} TRP, which correspond to the first and second diagonal blocks, and B_{2,1} and B_{2,2} are basis matrices for the first and second antenna polarizations of the 2^{nd} TRP, which correspond to the third and fourth diagonal blocks. In general, (2r−1)-th and (2r)-th diagonal blocks correspond to the two antenna polarizations for the r-th TRP. In one example, B_{r,p}=[b_{r,p,0}, b_{r,p,1}, . . . , b_{r,p,L}_{_{r,p}}₋₁] comprises L_{r,p} columns or beams (or basis vectors) for p-th polarization of r-th TRP. In one example, L_{r,p}=L for all r and p values (TRP-common and polarization-common L value), for example L∈{2,3,4,6}. In one example, L_{r,p}=Lᵣ for all p values (TRP-specific and polarization-common L value). In one example, L_{r,p}=Lₚ for all r values (TRP-common and polarization-specific L value). In one example, L_{r,p} can be different across TRPs (TRP-specific and polarization-specific L value).

In one example, when N_{TRP}=2, the components W₁ is given by

$${W}_{1} = [ \begin{matrix}{B}_{1 , 1} & 0 & 0 & 0 \\ 0 & {B}_{2 , 1} & 0 & 0 \\ 0 & 0 & {B}_{1 , 2} & 0 \\ 0 & 0 & 0 & {B}_{2 , 2}\end{matrix} ]$$

where B_{1,1} and B_{1,2} are basis matrices for the first and second antenna polarizations of the 1^{st} TRP, which correspond to the first and third diagonal blocks, and B_{2,1} and B_{2,2} are basis matrices for the first and second antenna polarizations of the 2^{nd} TRP, which correspond to the second and fourth diagonal blocks. In general, r-th and (r+N_{TRP})-th diagonal blocks correspond to the two antenna polarizations for the r-th TRP. In one example, B_{r,p}=[b_{r,p,0}, b_{r,p,1}, . . . , b_{r,p,L}_{_{r,p}}₋₁] comprises L_{r,p} columns or beams (or basis vectors) for p-th polarization of r-th TRP. In one example, L_{r,p}=L for all r and p values (TRP-common and polarization-common L value), for example L∈{2,3,4,6}. In one example, L_{r,p}=Lᵣ for all p values (TRP-specific and polarization-common L value). In one example, L_{r,p}=Lₚ for all r values (TRP-common and polarization-specific L value). In one example, L_{r,p} can be different across TRPs (TRP-specific and polarization-specific L value).

In one example,

$$X = {\sum }_{r = 1}^{{N}_{T R P}} {a}_{r} ,$$

where aᵣ=1 for co-polarized (single polarized) antenna structure at r-th TRP, and aᵣ=2 for dual-polarized (cross-polarized) antenna structure at r-th TRP.

In one example, when N_{TRP}=2, the components W₁ is given by

$${W}_{1} = [ \begin{matrix}{B}_{1} & 0 & 0 \\ 0 & {B}_{2} & 0 \\ 0 & 0 & {B}_{2}\end{matrix} ]$$

where B₁ is a basis matrix for the 1^{st} TRP, and B₂ is a basis matrix for the 2^{nd} TRP and is common (the same) for the two polarizations, which correspond to the second and third diagonal blocks.

In one example, when N_{TRP}=2, the components W₁ is given by

$${W}_{1} = [ \begin{matrix}{B}_{1} & 0 & 0 \\ 0 & {B}_{2 , 1} & 0 \\ 0 & 0 & {B}_{2 , 2}\end{matrix} ]$$

where B₁ is a basis matrix for the 1^{st} TRP, and B_{2,1} and B_{2,2} are basis matrices for the first and second antenna polarizations of the 2^{nd} TRP, which correspond to the second and third diagonal blocks.

FIG. 11 illustrates an example distributed MIMO system 1100 where each TRP has multiple antenna panels according to embodiments of the present disclosure. The embodiment of the distributed MIMO system 1100 where each TRP has multiple antenna panels illustrated in FIG. 11 is for illustration only. FIG. 11 does not limit the scope of this disclosure to any particular implementation of the distributed MIMO system 1100 where each TRP has multiple antenna panels.

As illustrated in FIG. 11, in one embodiment, each TRP has multiple antenna panels. The component W₁ has a block diagonal structure comprising X diagonal blocks, where N_{g,r} (co-pol) or 2N_{g,r} (dual-pol) diagonal blocks are associated with r-th TRP comprising N_{g,r} panels and N_{g,r}>1 for all values of r. Note N_{g,r}=2 for both TRPs in FIG. 11.

The examples herein can be extended in a straightforward manner in this case (of multiple panels at TRPs) by adding the diagonal blocks corresponding to multiple panels in W₁.

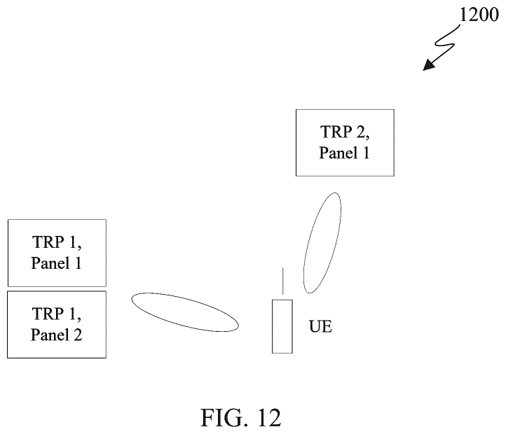

FIG. 12 illustrates an example distributed MIMO system 1200 where each TRP can have a single panel or have multiple panels according to embodiments of the present disclosure. The embodiment of the distributed MIMO system 1200 where each TRP can have a single panel or have multiple panels illustrated in FIG. 12 is for illustration only. FIG. 12 does not limit the scope of this disclosure to any particular implementation of the distributed MIMO system 1200 where each TRP can have a single panel or have multiple panels.

As illustrated in FIG. 12, in one embodiment, each TRP can have a single antenna panel or multiple antenna panels (cf. FIG. 12). The component W₁ has a block diagonal structure comprising X diagonal blocks, where N_{g,r} (co-pol) or 2N_{g,r} (dual-pol) diagonal blocks are associated with r-th TRP comprising N_{g,r} panels, and N_{g,r}=1 when r-th TRP has a single panel and N_{g,r}>1 when r-th TRP has multiple panels.

The examples described herein can be extended in a straightforward manner in this case (of multiple panels at TRPs) by adding the diagonal blocks corresponding to multiple panels in W₁.

In one embodiment, the basis matrices comprising the diagonal blocks of the component W₁ have columns that are selected from a set of oversampled 2D DFT vectors. When the antenna port layout is the same across TRPs, for a given antenna port layout (N₁, N₂) and oversampling factors (O₁, O₂) for two dimensions, a DFT vector v_{l,m} can be expressed as follows.

$${v}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}} {u}_{m}\end{matrix} ]}^{T}$$

$${u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ]$$

where l∈{0,1, . . . , O₁N₁−1} and m∈{0,1, . . . , O₂N₂−1}.

When the antenna port layout can be different across TRPs, for a given antenna port layout (N_{1,r}, N_{2,r}) and oversampling factors (O_{1,r}, O_{2,r}) associated with r-th TRP, a DFT vector Vₗ_{ᵣ}_{,m}_{ᵣ} can be expressed as follows.

$${v}_{{l}_{r} , {m}_{r}} = {[ \begin{matrix}{u}_{{m}_{r}} & {e}^{j \frac{2 π {l}_{r}}{{O}_{1 , r} {N}_{1 , r}}} {u}_{{m}_{r}} & … & {e}^{j \frac{2 π {l}_{r} ( {N}_{1 , r} - 1 )}{{O}_{1 , r} {N}_{1 , r}}} {u}_{{m}_{r}}\end{matrix} ]}^{T}$$

$${u}_{{m}_{r}} = [ \begin{matrix}1 & {e}^{j \frac{2 π {m}_{r}}{{O}_{2 , r} {N}_{2 , r}}} & … & {e}^{j \frac{2 π {m}_{r} ( {N}_{2 , r} - 1 )}{{O}_{2 , r} {N}_{2 , r}}}\end{matrix} ]$$

where lᵣ∈{0,1, . . . , O_{1,r}N_{1,r}−1} and mᵣ∈{0,1, . . . , O_{2,r} N_{2,r}−1}.

In one example, the oversampling factor is TRP-common, hence remains the same across TRPs. For example, e.g. O_{1,r}=O₁=O_{2,r}=O₂=4. In one example, the oversampling factor is TRP-specific, hence is independent for each TRP. For example, O_{1,r}=O_{2,r}=x and x is chosen (fixed or configured) from {2,4,8}.

In one embodiment, the basis matrices comprising the diagonal blocks of the component W₁ have columns that are selected from a set of port selection vectors. When the antenna port layout is the same across TRPs, for a given number of CSI-RS port P_{CSI-RS}, a port selection vector vₘ is a P_{CSI-RS}/2-element column vector containing a value of 1 in element

$$( m mod \frac{{P}_{CSI - RS}}{2} )$$

and zeros elsewhere (where the first element is element 0).

When the antenna port layout can be different across TRPs, for a given number of CSI-RS port P_{CSI-RS,r}, a port selection vector Vₘ_{ᵣ} is a P_{CSI-RS,r}/2-element column vector containing a value of 1 in element

$$( {m}_{r} mod \frac{{P}_{CSI - RS , r}}{2} )$$

and zeros elsewhere (where the first element is element 0).

In one embodiment, each TRP can have a single antenna panel or multiple antenna panels (cf. FIG. 12). The component W₁ has a block diagonal structure comprising X=2 diagonal blocks, where N_{g,r} (co-pol) or 2N_{g,r} (dual-pol) diagonal blocks are associated with r-th TRP comprising N_{g,r} panels, and N_{g,r}=1 when r-th TRP has a single panel and N_{g,r}>1 when r-th TRP has multiple panels.

In the following, a term polarization is used to refer to a group/subset of CSI-RS ports. For example, a first antenna polarization corresponds to a first group/subset of CSI-RS ports

$$\{ X , X + 1 , … , X + \frac{{P}_{CSIRS}}{2} + 1 \} ,$$

and a second antenna polarization corresponds to a second group/subset of CSI-RS ports

$$\{ X + \frac{{P}_{CSIRS}}{2} , X + \frac{{P}_{CSIRS}}{2} + 1 , … , X + {P}_{CSIRS} + 1 \} .$$

Here, P_{CSIRS} is a total number of CSI-RS ports the CSI reporting is configured for. In one example, X=3000 is the first CSI-RS port index.

In the following, a TRP can refer to a CSI-RS resource (configured for channel measurement), or a group of CSI-RS ports within a CSI-RS resource (comprising multiple groups of CSI-RS ports).

In one embodiment, the component W₁ is TRP-common port selection (or TRP-common SD basis beam selection), i.e., a same set of ports is selected for all TRPs.

In one example, the component W₁ is TRP-common, polarization common, and layer-common (i.e., the same set of CSI-RS ports is selected/reported for all TRPs, for both antenna polarizations, and for all layers). For example, the W₁ can be expressed as:

$${W}_{1}^{( ℓ )} = {W}_{1} = [ \begin{matrix}B & 0 & 0 \\ 0 & ⋱ & 0 \\ 0 & 0 & B\end{matrix} ] , ℓ = 1 , … , V ,$$

where V is a number of layers,

$${W}_{1}^{( ℓ )}$$

is W₁ of the [symbol] -th layer, B includes a common set of port selection vectors for all TRPs, dual polarized antenna ports, and layers. In one example, when N_{TRP}=2, W₁=diag (B,B,B,B) for dual-polarized case, where diag (A, B, C, . . . ) is the block diagonal matrix composed of A, B, C, . . . matrices in the block diagonal way. In one example B=[b₀, b₁, . . . , b_{L-1}], where L is a number of port selection vectors. When the antenna port layout is the same across TRPs and the number of CSI-RS ports per TRP is P_{CSI-RS} (i.e., P_{CSI-RS,total}=N_{TRP} P_{CSI-RS}), the same L ports are selected out of

$$\frac{{P}_{CSI - RS}}{2}$$

(assuming a qual-polarized case) across TRPs and layers. In this case, an indicator with cardinality (payload)

$$⌈ {log}_{2} ( \begin{matrix}\frac{{P}_{CSI - RS}}{2} \\ L\end{matrix} ) ⌉$$

bits is needed to indicate selected L ports for all layers, and this indicator is reported in CSI reporting, e.g., as a PMI component.

In one example, the component W₁ is TRP-common, polarization common, and layer-specific (i.e., for each layer, a same set of CSI-RS ports is selected/reported for all TRPs, and for both antenna polarizations). For example, the W₁ can be expressed as:

$${W}_{1}^{( ℓ )} = [ \begin{matrix}{B}^{( ℓ )} & 0 & 0 \\ 0 & ⋱ & 0 \\ 0 & 0 & {B}^{( ℓ )}\end{matrix} ] , ℓ = 1 , ⋯ , V ,$$

where V is a number of layers,

$${W}_{1}^{( ℓ )}$$

is W₁ of the [symbol] -th layer, [symbol] includes a common set of port selection vectors for all TRPs and dual polarized antenna ports. In one example

$${B}^{( ℓ )} = [ {b}_{0}^{( ℓ )} , {b}_{1}^{( ℓ )} , … , {b}_{L - 1}^{( ℓ )} ] ,$$

where L is a number of port selection vectors. When the antenna port layout is the same across TRPs and the number of CSI-RS ports per TRP is P_{CSI-RS} (i.e., P_{CSI-RS,total}=N_{TRP}P_{CSI-RS}), the same L ports are selected out of

$$\frac{{P}_{CSI - RS}}{2}$$

(assuming a qual-polarized case) across TRPs for each layer. In this case, as an example, an indicator with cardinality (payload)

$$⌈ {log}_{2} ( \begin{matrix}\frac{{P}_{CSI - RS}}{2} \\ L\end{matrix} ) ⌉$$

is needed to indicate selected L ports for each layer, and each indicator is reported in CSI reporting, e.g., as a PMI component.

In another example, L depends on layer (index [symbol] ). In this case,

$${B}^{( ℓ )} = [ {b}_{0}^{( ℓ )} , {b}_{1}^{( ℓ )} , … , {b}_{{L}_{ℓ} - 1}^{( ℓ )} ] ,$$

and thus, in one example, an indicator with cardinality (payload)

$$⌈ {log}_{2} ( \begin{matrix}\frac{{P}_{CSI - RS}}{2} \\ {L}_{ℓ}\end{matrix} ) ⌉$$

is needed to indicate selected [symbol] ports for each layer [symbol] .

In one example, the component W₁ is TRP-common, polarization specific, and layer-common (i.e., for each polarization, a same set of CSI-RS ports is selected/reported for all TRPs and for all layers. For example, the W₁ can be expressed as:

$${W}_{1}^{( ℓ )} = {W}_{1} = [ \begin{matrix}{B}_{0 , 1} & 0 & 0 & 0 & 0 \\ 0 & {B}_{0 , 2} & 0 & 0 & 0 \\ 0 & 0 & ⋱ & 0 & 0 \\ 0 & 0 & 0 & {B}_{0 , 1} & 0 \\ 0 & 0 & 0 & 0 & {B}_{0 , 2}\end{matrix} ] , ℓ = 1 , ⋯ , V ,$$

where V is a number of layers,

$${W}_{1}^{( ℓ )}$$

is W₁ of the [symbol] -th layer, B_{0,k} includes a common set of port selection vectors for all TRPs and layers for k-th polarization (where k=1,2). In one example B_{0,k}=[b_{0,k}, b_{1,k}, . . . , b_{L-1,k}], where L is a number of port selection vectors, for k-th polarization.

When the antenna port layout is the same across TRPs and the number of CSI-RS ports per TRP is P_{CSI-RS} (i.e., P_{CSI-RS,total}=N_{TRP}P_{CSI-RS}), the same L ports are selected out of

$$\frac{{P}_{CSI - RS}}{2}$$

(assuming a dual-polarized case) across TRPs and layers for each opalization. In this case, as an example, an indicator with cardinality (payload)

$$⌈ {log}_{2} ( \begin{matrix}\frac{{P}_{CSI - RS}}{2} \\ L\end{matrix} ) ⌉$$

is needed to indicate selected L ports for all TRPs and layers for each polarization, and each indicator is reported in CSI reporting, e.g., as a PMI component.

In another example, L depends on polarization (index k). In this case, B_{0,k}=[b_{0,k}, b_{1,k}, . . . , b_{L}_{ₖ}_{-1,k}], and thus, in one example, an indicator with cardinality (payload)

$$⌈ {log}_{2} ( \begin{matrix}\frac{{P}_{CSI - RS}}{2} \\ {L}_{k}\end{matrix} ) ⌉$$

is needed to indicate selected Lₖ ports for each polarization k.

In one example, the component W₁ is TRP-common, polarization-specific, and layer-specific (i.e., for each polarization, for each layer, a same set of CSI-RS ports is selected/reported for all TRPs. For example, the W₁ can be expressed as:

$${W}_{1}^{( ℓ )} = [ \begin{matrix}{B}_{0 , 1}^{( ℓ )} & 0 & 0 & 0 & 0 \\ 0 & {B}_{0 , 2}^{( ℓ )} & 0 & 0 & 0 \\ 0 & 0 & ⋱ & 0 & 0 \\ 0 & 0 & 0 & {B}_{0 , 1}^{( ℓ )} & 0 \\ 0 & 0 & 0 & 0 & {B}_{0 , 2}^{( ℓ )}\end{matrix} ] , ℓ = 1 , ⋯ , V ,$$

where V is a number of layers,

$${W}_{1}^{( ℓ )}$$

is W₁ of the [symbol] -th layer,

$${B}_{0 , k}^{( ℓ )}$$

includes a common set of port selection vectors for all TRPs for each layer for k-th polarization (where k=1,2). In one example

$${B}_{0 , k}^{( ℓ )} = [ {b}_{0 , k}^{( ℓ )} , {b}_{1 , k}^{( ℓ )} , … , {b}_{L - 1 , k}^{( ℓ )} ] ,$$

where L is a number of port selection vectors for layer [symbol] for the k-th polarization.

When the antenna port layout is the same across TRPs and the number of CSI-RS ports per TRP is P_{CSI-RS} (i.e., P_{CSI-RS,total}=N_{TRP}P_{CSI-RS}), the same L ports are selected out of

$$\frac{{P}_{CSI - RS}}{2}$$

(assuming a dual-polarized case) across TRPs for each layer for each polarization. In this case, as an example, an indicator with cardinality (payload)

$$⌈ {log}_{2} ( \begin{matrix}\frac{{P}_{CSI - RS}}{2} \\ L\end{matrix} ) ⌉$$

is needed to indicate selected L ports for all TRPs for each layer for each polarization, and each indicator is reported in CSI reporting, e.g., as a PMI component.

In another example, L depends on polarization k and/or layer [symbol] . In one example,

$${B}_{0 , k}^{( ℓ )} = [ {b}_{0 , k}^{( ℓ )} , {b}_{1 , k}^{( ℓ )} , … , {b}_{{L}_{k} - 1 , k}^{( ℓ )} ] ,$$

and thus, in one example, an indicator with cardinality (payload)

$$⌈ {log}_{2} ( \begin{matrix}\frac{{P}_{CSI - RS}}{2} \\ {L}_{k}\end{matrix} ) ⌉$$

is needed to indicate selected Lₖ ports for each polarization k. In another example,

$${B}_{0 , k}^{( ℓ )} = [ {b}_{0 , k}^{( ℓ )} , {b}_{1 , k}^{( ℓ )} , … , {b}_{{L}_{ℓ} - 1 , k}^{( ℓ )} ] ,$$

and thus, in one example, an indicator with cardinality (payload)

$$⌈ {log}_{2} ( \begin{matrix}\frac{{P}_{CSI - RS}}{2} \\ {L}_{ℓ}\end{matrix} ) ⌉$$

is needed to indicate selected [symbol] ports for each layer [symbol] . In another example,

$${B}_{0 , k}^{( ℓ )} = [ {b}_{0 , k}^{( ℓ )} , {b}_{1 , k}^{( ℓ )} , … , {b}_{{L}_{ℓ ( i )} - 1 , k}^{( ℓ )} ] ,$$

and thus, in one example, an indicator with cardinality (payload)

$$⌈ {log}_{2} ( \begin{matrix}\frac{{P}_{CSI - RS}}{2} \\ {L}_{ℓ ( k )}\end{matrix} ) ⌉$$

is needed to indicate selected [symbol] ports for each layer [symbol] for each polarization k.

In one embodiment, the component W₁ is TRP-specific port selection (or TRP-specific SD basis beam selection), i.e., an independent set of ports is selected/reported for each TRP.

In the present disclosure, TRP index i can be determined based on CSI-RS port number, CSI-RS resource IDs. In another example, TRP index i can be determined based on RSRP/RSRQ/SINR (which can be, e.g., based on UE measurement), and can be configured by NW or reported by UE.

In one example, the component W₁ is TRP-specific, polarization common, and layer-common (i.e., for each TRP, a common set of CSI-RS ports is selected/reported for all layers, and for both antenna polarizations). For example, the W₁ can be expressed as:

$${W}_{1}^{( ℓ )} = {W}_{1} = [ \begin{matrix}{B}_{1} & 0 & 0 & 0 & 0 \\ 0 & {B}_{1} & 0 & 0 & 0 \\ 0 & 0 & ⋱ & 0 & 0 \\ 0 & 0 & 0 & {B}_{{N}_{TRP}} & 0 \\ 0 & 0 & 0 & 0 & {B}_{{N}_{TRP}}\end{matrix} ] , ℓ = 1 , ⋯ , V ,$$

where V is a number of layers,

$${W}_{1}^{( ℓ )}$$

is W₁ of the [symbol] -th layer, Bᵢ includes an independent set of port selection vectors for TRP i but the set is the same across polarizations and layers. In one example, when N_{TRP}=2, W₁=diag(B₁, B₁, B₂, B₂) for dual-polarized case, where diag(A, B, C, . . . ) is the block diagonal matrix composed of A, B, C, . . . matrices in the block diagonal way. In one example Bᵢ=[b_{i,0}, b_{i,1}, . . . , b_{i,L-1}], where L is a number of port selection vectors for TRP i. When the antenna port layout is the same across TRPs and the number of CSI-RS ports per TRP is P_{CSI-RS} (i.e., P_{CSI-RS,total}=N_{TRP} P_{CSI-RS}), the same L ports are selected out of

$$\frac{{P}_{CSI - RS}}{2}$$

(assuming a dual-polarized case) across polarizations and layers. In this case, an indicator with cardinality (payload)

$$⌈ {log}_{2} ( \begin{matrix}\frac{{P}_{CSI - RS}}{2} \\ L\end{matrix} ) ⌉$$

is needed to indicate selected L ports for all layers and polarizations for each TRP, and each indicator is reported in CSI reporting. In another example, L depends on TRP.

The reporting of the (indices) of the port selection vectors for all TRPs can be via one joint indicator, or via multiple (separate) indicators, one for each TRP.

In one example, Bᵢ includes Lᵢ port selection vectors (TRP-specific the number of port selection vectors), i.e., Bᵢ=[b_{i,0}, b_{i,1}, . . . , b_{i,L}_{ᵢ}₋₁], where Lᵢ is a number of port selection vectors for TRP i. In one example, L₁=2, L₂=4, and so on.
In one example, Lᵢ s are selected from a same set of [symbol] . For example, [symbol] ={1,2}, [symbol] ={1,2,3}, or [symbol] ={1,2,3,4}.
In one example, Lᵢ for each TRP i is selected from a corresponding set of [symbol] ᵢ. For example, [symbol] ₁={1,2,3,4}, [symbol] ₂={1,2}, and so on.
In another example, (L₁, . . . , L_{N}_{_{TRP}}) are selected from a set [symbol] ⱼₒᵢₙₜ for joint indicator. For example, when N_{TRP}=2, [symbol] ⱼₒᵢₙₜ={(2,2), (2,3), (2,4), (3,4)}.

In one example, Lᵢs are configured by NW via RRC, MAC-CE, and/or DCI. In one example, some of Lᵢs are configured, and the others are fixed or determined based on configured values. In one example, a UE determines and reports L₁ and/or L₂, and so on.

In one example, B₁ and B₂ include L₁ port selection vectors and B₃ and B₄ include L₂ port selection vectors (TRP-pair-specific the number of port selection vectors), i.e., Bᵢ=[b_{i,0}, b_{i,1}, . . . , b_{i,L}_{₁}₋₁] for i∈{1,2} and Bᵢ=[b_{i,0}, b_{i,1}, . . . , b_{i,L}_{₂}₋₁] for i∈{3,4}. In one example, (L₁, L₂)=(4,2),
In one example, L₁ and L₂ are selected from a same set of [symbol] . For example, [symbol] ={1,2}, [symbol] ={1,2,3}, or [symbol] ={1,2,3,4}.
In one example, [symbol] ᵢ is selected from a corresponding set of [symbol] ᵢ. For example, [symbol] 1={1,2,3,4}, [symbol] ₂={1,2}.
In another example, (L₁, L₂) are selected from a set [symbol] ⱼₒᵢₙₜ for joint indicator. For example, [symbol] ⱼₒᵢₙₜ={(2,2), (2,3), (2,4), (3,4)}.

In one example, Lᵢs are configured by NW via RRC, MAC-CE, and/or DCI. In one example, one of Lis are configured and the other is fixed or determined based on configured values. In one example, a UE determines and reports L₁ and/or L₂.

In one example, when N_{TRP}≤x, one L value is used for all TRPs, and when N_{TRP}>x, two L values are used, where x is a threshold value, which can be fixed e.g., 2 or configured.

For example, if x is fixed to 2, we can have

$${B}_{i} = [ {b}_{i , 0} , {b}_{i , 1} , … , {b}_{i , L - 1} ] for i = 1 , 2 when {N}_{T R P} = 2.$$

$${B}_{i} = [ {b}_{i , 0} , {b}_{i , 1} , … , {b}_{i , {L}_{1} - 1} ] for i = 1 , 2 , {B}_{i} = [ {b}_{i , 0} , {b}_{i , 1} , … , {b}_{i , {L}_{2} - 1} ] for i = 3 , 4 ,$$

$$when$$

$${N}_{T R P} = 3 or 4.$$

In one example, (L₁,L₂)=(2,4), (3,4), or another pair value.

In one example, L₁ and L₂ are selected from a same set of [symbol] . For example, [symbol] ={1,2}, [symbol] ={1,2,3}, or [symbol] ={1,2,3,4}.

In one example, Lᵢ is selected from a corresponding set of [symbol] ᵢ. For example, [symbol] ₁={1,2,3,4}, [symbol] ₂={1,2}.

In another example, (L₁, L₂) are selected from a set [symbol] ′ for joint indicator. For example, [symbol] ′={(2,2), (2,3), (2,4), (3,4)}.

In one example, Lis are configured by NW via RRC, MAC-CE, and/or DCI. In one example, one of Lᵢs are configured and the other is fixed or determined based on configured values. In one example, a UE determines and reports L₁ and/or L₂.

In one example, a total number of port selection vectors for all TRPs is Lₛᵤₘ.

In one example, Lₛᵤₘ is configured by NW via RRC, MAC-CE, and/or DCI. In another example, Lₛᵤₘ is fixed, e.g., Lₛᵤₘ=4. In one example, Lₛᵤₘ is determined by UE and reported.

In one example, Lₛᵤₘ is selected from a set [symbol] ₛᵤₘ, e.g., [symbol] ₛᵤₘ={4,5,6,7}.

In one example, when N_{TRP}≤x, Lₛᵤₘ is a first value, and when N_{TRP}>X, Lₛᵤₘ is a second value, where x is a threshold value, which can be fixed e.g., 2 or configured. In one example, (the first value, the second value) are configured or fixed.

In one example, Lᵢ value is layer-common and rank-common.

In one example, L′ value is layer-common and rank-common.

In one example, Lᵢ value is layer-specific and rank-common.

In one example, L′ value is layer-specific and rank-common.

In one example, Lᵢ value is layer-common and rank-specific.

In one example, L′ value is layer-common and rank-specific.

In one example, Lᵢ value is layer-specific and rank-specific.

In one example, L′ value is layer-specific and rank-specific.

In the above examples, TRP index i can be determined based on CSI-RS port number, CSI-RS resource IDs. In another example, TRP index i can be determined based on RSRP/RSRQ/SINR (which can be, e.g., based on UE measurement), and can be configured by NW or reported by UE.

In one example, the component W₁ is TRP-specific, polarization common, and layer-specific (i.e., for each TRP and for each layer, a common set of CSI-RS ports is selected/reported for both antenna polarizations). For example, the W₁ can be expressed as:

$${W}_{1}^{( ℓ )} = [ \begin{matrix}{B}_{1}^{( ℓ )} & 0 & 0 & 0 & 0 \\ 0 & {B}_{1}^{( ℓ )} & 0 & 0 & 0 \\ 0 & 0 & ⋱ & 0 & 0 \\ 0 & 0 & 0 & {B}_{{N}_{TRP}}^{( ℓ )} & 0 \\ 0 & 0 & 0 & 0 & {B}_{{N}_{TRP}}^{( ℓ )}\end{matrix} ] , ℓ = 1 , ⋯ , V ,$$

where V is a number of layers,

$${W}_{1}^{( ℓ )}$$

is W₁ of the [symbol] -th layer,

$${B}_{i}^{( ℓ )}$$

includes an independent set of port selection vectors for TRP i for layer [symbol] but the set is the same across polarizations. In one example

$${B}_{i} = [ {b}_{i , 0}^{( ℓ )} , {b}_{i , 1}^{( ℓ )} , … , {b}_{i , L - 1}^{( ℓ )} ] ,$$

where L is a number of port selection vectors for TRP i for layer [symbol] . When the antenna port layout is the same across TRPs and the number of CSI-RS ports per TRP is P_{CSI-RS} (i.e., P_{CSI-RS,total}=N_{TRP}P_{CSI-RS}), the same L ports are selected out of

$$\frac{{P}_{CSI - RS}}{2}$$

(assuming a dual-polarized case) across polarizations. In this case, an indicator with cardinality (payload)

$$⌈ {log}_{2} ( \begin{matrix}\frac{{P}_{CSI - RS}}{2} \\ L\end{matrix} ) ⌉$$

is needed to indicate selected L ports for all polarizations for each TRP i for each layer [symbol] , and each indicator is reported in CSI reporting. In another example, L depends on TRP and/or layer.

In one or more examples, L and relevant parameters can be extended according to one or more examples described herein.

In one example, the component W₁ is TRP-specific, polarization-specific, and layer-common (i.e., for each TRP and for each polarization, a common set of CSI-RS ports is selected/reported for all layers). For example, the W₁ can be expressed as:

$${W}_{1}^{( ℓ )} = {W}_{1} = [ \begin{matrix}{B}_{1 , 1} & 0 & 0 & 0 & 0 \\ 0 & {B}_{1 , 2} & 0 & 0 & 0 \\ 0 & 0 & ⋱ & 0 & 0 \\ 0 & 0 & 0 & {B}_{{N}_{TRP} , 1} & 0 \\ 0 & 0 & 0 & 0 & {B}_{{N}_{TRP} , 2}\end{matrix} ] , ℓ = 1 , ⋯ , V ,$$

where V is a number of layers,

$${W}_{1}^{( ℓ )}$$

is W₁ of the [symbol] -th layer, B_{i,k} includes an independent set of port selection vectors for TRP i for polarization k but the set is the same across layers. In one example B_{i,k}=[b_{i,0,k}, b_{i,1,k}, . . . , b_{i,L-1,k}], where L is a number of port selection vectors for TRP i for polarization k. When the antenna port layout is the same across TRPs and the number of CSI-RS ports per TRP is P_{CSI-RS} (i.e., P_{CSI-RS,total}=N_{TRP}P_{CSI-RS}), the same L ports are selected out of

$$\frac{{P}_{CSI - RS}}{2}$$

(assuming a dual-polarized case) across layers. In this case, an indicator with cardinality (payload)

$$⌈ {log}_{2} ( \begin{matrix}\frac{{P}_{CSI - RS}}{2} \\ L\end{matrix} ) ⌉$$

is needed to indicate selected L ports for all layers for each TRP i for each polarization k, and each indicator is reported in CSI reporting. In another example, L depends on TRP and/or polarization.

In one or more examples, L and relevant parameters can be extended according to one or more examples described herein.

In one example, the component W₁ is TRP-specific, polarization-specific, and layer-specific (i.e., for each TRP, for each polarization, and for each layer, a set of CSI-RS ports is selected/reported). For example, the W₁ can be expressed as:

$${W}_{1}^{( ℓ )} = [ \begin{matrix}{B}_{1 , 1}^{( ℓ )} & 0 & 0 & 0 & 0 \\ 0 & {B}_{1 , 2}^{( ℓ )} & 0 & 0 & 0 \\ 0 & 0 & ⋱ & 0 & 0 \\ 0 & 0 & 0 & {B}_{{N}_{TRP} , 1}^{( ℓ )} & 0 \\ 0 & 0 & 0 & 0 & {B}_{{N}_{TRP} , 2}^{( ℓ )}\end{matrix} ] , ℓ = 1 , … , V ,$$

where V is a number of layers,

$${W}_{1}^{( ℓ )}$$

is W₁ of the [symbol] -th layer,

$${B}_{i , k}^{( ℓ )}$$

includes a common set of port selection vectors for TRP i for polarization k for layer [symbol] . In one example

$${B}_{i ,}^{( ℓ )} = [ {b}_{i , 0. k}^{( ℓ )} , {b}_{i , 1 , {k}^{′}}^{( ℓ )} , … , {b}_{i , L - 1 , k}^{( ℓ )} ] ,$$

where L is a number of port selection vectors for TRP i for polarization k for layer [symbol] . When the antenna port layout is the same across TRPs and the number of CSI-RS ports per TRP is P_{CSI-RS} (i.e., P_{CSI-RS,total}=N_{TRP}P_{CSI-RS}), L ports are independently selected out of

$$\frac{{P}_{CSI - RS}}{2}$$

(assuming a dual-polarized case) for TRP/polarization/layer. In this case, an indicator with cardinality (payload)

$$⌈ {log}_{2} ( \frac{{P}_{CSI - RS}}{\begin{matrix}2 \\ L\end{matrix}} ) ⌉$$

is needed to indicate selected L ports for each TRP i for each polarization k for each layer [symbol] , and each indicator is reported in CSI reporting. In another example, L depends on TRP, polarization, and/or layer.

In one or more examples, L and relevant parameters can be extended according to one or more examples described herein.

In one embodiment, the component W₁ is TRP-specific port selection (or TRP-specific SD basis beam selection) under a constraint that a total number of selected ports is Lₛᵤₘ. In this embodiment, under the constraint that a total number of selected ports is Lₛᵤₘ, Bᵢ includes Lᵢ port selection vectors for TRP i, where Lₛᵤₘ=ΣᵢLᵢ.

In one example, Lₛᵤₘ is configured by NW via RRC, MAC-CE, and/or DCI. In another example, Lₛᵤₘ is fixed, e.g., Lₛᵤₘ=4. In one example, Lₛᵤₘ is determined by UE and reported.

In one example, Lₛᵤₘ is selected from a set [symbol] ₛᵤₘ, e.g., [symbol] ₛᵤₘ={4,5,6,7}.

In one example, when N_{TRP}≤x, Lₛᵤₘ is a first value, and when N_{TRP}>x, Lₛᵤₘ is a second value, where x is a threshold value, which can be fixed e.g., 2 or configured. In one example, (the first value, the second value) are configured or fixed.

In one example, the component W₁ is TRP-specific, polarization-common, and layer-common.

In one example, the component W₁ is TRP-specific, polarization-common, and layer-specific. In this case, Lₛᵤₘ can depend on layer [symbol] , e.g., Lₛᵤₘ ( [symbol] ). In another example, Lₛᵤₘ is fixed for all layers.

In one example, the component W₁ is TRP-specific, polarization-specific, and layer-common. Lₛᵤₘ can depend on polarization k, e.g., Lₛᵤₘ (k). In another example, Lₛᵤₘ is fixed for all polarizations.

In one example, the component W₁ is TRP-specific, polarization-specific, and layer-specific. Lₛᵤₘ can depend on layer & and/or polarization k, e.g., Lₛᵤₘ ( [symbol] , k). In another example, Lₛᵤₘ is fixed for all layers and polarizations.

In one embodiment, the component W₁ is TRP-pair common port selection (or TRP-pair common SD basis beam selection), i.e., a same set of ports is selected for each TRP pair.

In one example, the component W₁ is TRP-pair common, polarization-common, and layer-common. For example, when N_{TRP}=4, two TRP pairs exist. In this case, the W₁ can be expressed as

$${W}_{1}^{( ℓ )} = {W}_{1} = diag ( {B}_{12} , {B}_{12} , {B}_{12} , {B}_{12} , {B}_{34} , {B}_{34} , {B}_{34} , {B}_{34} ) ,$$

where B₁₂=[b_{12,0}, . . . , b_{12,L-1}] and B₃₄=[b_{34,0}, . . . , b_{34,L-1}] are port selection vectors for TRP pairs (i.e., TRPs 1 and 2, TRPs 3 and 4), respectively. In this case, an indicator with cardinality

$$⌈ {log}_{2} ( \frac{{P}_{CSI - RS}}{\begin{matrix}2 \\ L\end{matrix}} ) ⌉$$

is needed to indicate selected L ports for each TRP pair, and each indicator is used in CSI reporting.

In one example, the component W₁ is TRP-pair common, polarization-common, and layer-specific.

In one example, the component W₁ is TRP-pair common, polarization-specific, and layer-common.

In one example, the component W₁ is TRP-pair common, polarization-specific, and layer-specific.

In one embodiment, the component W₁ includes port selection vectors for a subset of the TRPs.

In one embodiment, for the subset of the TRPs, the component W₁ is TRP-common port selection (or TRP-common SD basis beam selection), i.e., a same set of ports is selected for all TRPs.

In one example, the component W₁ is TRP-common, polarization-common, and layer-common.

In one example, the component W₁ is TRP-common, polarization-common, and layer-specific.

In one example, the component W₁ is TRP-common, polarization-specific, and layer-common.

In one example, the component W₁ is TRP-common, polarization-specific, and layer-specific.

In one embodiment, for the subset of the TRPs, the component W₁ is TRP-specific port selection (or TRP-specific SD basis beam selection), i.e., an independent set of ports is selected for each TRP.

In one example, the component W₁ is TRP-specific, polarization-common, and layer-common.

In one example, the component W₁ is TRP-specific, polarization-common, and layer-specific.

In one example, the component W₁ is TRP-specific, polarization-specific, and layer-common.

In one example, the component W₁ is TRP-specific, polarization-specific, and layer-specific.

Similar to Rel-17 Type-II port-selection codebook, the number L of selected ports can be parameterized by α with the number of CSI-RS ports. For example, L=2K₁ and K₁=αP_{CSIRS}, where α takes a value from {¼, ½, ¾, 1}.

In one embodiment, the component W_{f} is according to at least one of the following examples.

In one example, the component W_{f} is TRP-common and layer-common, i.e., one common W_{f} is reported for all TRPs and for all layers (when number of layers or rank>1).

In one example, the component W_{f} is TRP-common and layer-specific, i.e., for each layer l∈{1, . . . , v}, where v is a rank value or number of layers, one common W_{f} is reported for all TRPs.

In one example, the component W_{f} is TRP-specific and layer-common, i.e., for each TRP r∈{1, . . . , N_{TRP}}, one common W_{f} is reported for all layers.

In one example, the component W_{f} is TRP-specific and layer-specific, i.e., for each TRP r∈{1, . . . , N_{TRP}} and for each layer l∈{1, . . . , v}, one W_{f} is reported.

In one example, the component W_{f} is TRP-pair-common and layer-common, i.e., one common W_{f} is reported for each TRP pair and for all layers (when number of layers or rank>1).

In one example, the component W_{f} is TRP-pair-common and layer-specific, i.e., for each layer l∈{1, . . . , v}, where v is a rank value or number of layers, one common W_{f} is reported for each TRP pair.

In one embodiment, let W_{f} comprise Mᵥ columns for a given rank value v. The value of Mᵥ can be fixed (e.g., 1 or 2). or configured via higher layer (RRC) signaling (similar to R16 enhanced Type II codebook) or reported by the UE as part of the CSI report). The value of Mᵥ and some other parameters (e.g., α, β as Rel-17 Type-II CB) can be jointly parameterized and the joint parameter can be configured by NW. The value of Mᵥ is according to at least one of the following examples. In one example, Mᵥ∈{1,2} when W₁ comprises port selection vectors, i.e., when the UE is configured with a port selection Type II codebook, as described in this disclosure. In one example,

$${M}_{υ} = ⌈ \frac{{p}_{υ} {N}_{3}}{R} ⌉$$

when W₁ comprises DFT basis vectors, i.e., when the UE is configured with a regular Type II codebook, as described in this disclosure, and as in section 5.2.2.2.5 TS 38.214.

In one example, the value of Mᵥ is TRP-common, layer-common, and RI-common. The same Mᵥ value is used common for all values of N_{TRP}, v, and layers=1, . . . , v.

In one example, the value of Mᵥ is TRP-common, layer-common, and RI-specific. For each RI value v, the same Mᵥ value is used common for all values of N_{TRP} and layers=1, . . . , v.

In one example, the value of Mᵥ is TRP-common, layer-specific, and RI-common. For each layers=1, . . . , v, the same Mᵥ value is used common for all values of N_{TRP} and v.

In one example, the value of Mᵥ is TRP-specific, layer-common, and RI-common. For each TRP r∈{1, . . . , N_{TRP}}, the same Mᵥ value is used common for all values of v and layers=1, . . . , v.

In one example, the value of Mᵥ is TRP-common, layer-specific, and RI-specific.

In one example, the value of Mᵥ is TRP-specific, layer-specific, and RI-common.

In one example, the value of Mᵥ is TRP-specific, layer-common, and RI-specific.

In one example, the value of Mᵥ is TRP-specific, layer-specific, and RI-specific.

In one example, the value of Mᵥ is TRP-pair-common, layer-common, and RI-common.

In one example, the value of Mᵥ is TRP-pair-common, layer-common, and RI-specific.

In one example, the value of Mᵥ is TRP-pair-common, layer-specific, and RI-common.

In one example, the value of Mᵥ is TRP-pair-common, layer-specific, and RI-specific.

In one embodiment, the columns of W_{f} are selected from a set of oversampled DFT vectors. When the antenna port layout is the same across TRPs, for a given N₃ and oversampling factors O₃, a DFT vector y_{f} can be expressed as follows.

$${y}_{f} = [ \begin{matrix}1 & {e}^{j \frac{2 π f}{{O}_{3} {N}_{3}}} & … & {e}^{j \frac{2 π f ( {N}_{3} - 1 )}{{O}_{3} {N}_{3}}}\end{matrix} ]$$

where f∈{0,1, . . . , O₃N₃−1}.

When N₃ value can be different across TRPs, for r-th TRP, a DFT vector y_{f}_{ᵣ} can be expressed as follows.

$${y}_{f} = [ \begin{matrix}1 & {e}^{j \frac{2 π {f}_{r}}{{O}_{3 , r} {N}_{3 , r}}} & … & {e}^{j \frac{2 π {f}_{r} ( {N}_{3} - 1 )}{{O}_{3 , r} {N}_{3 , r}}}\end{matrix} ]$$

where fᵣ∈{0,1, . . . , O_{3,r}N_{3,r}−1}.

In one example, the oversampling factor is TRP-common, hence remains the same across TRPs. For example, e.g., O_{3,r}=O₃. In one example, the oversampling factor is TRP-specific, hence is independent for each TRP. For example, O_{3,r}=x and x is chosen (fixed or configured) from {1,2,4,8}. In one example, the oversampling factor=1. Then, the DFT vector y_{f} can be expressed as follows.

$${y}_{f} = [ \begin{matrix}1 & {e}^{j \frac{2 π f}{{N}_{3}}} & … & {e}^{j \frac{2 π f ( {N}_{3} - 1 )}{{N}_{3}}}\end{matrix} ] .$$

In one embodiment, the columns of We are selected from a set of port selection vectors. When N₃ value is the same across TRPs, for a given N₃ value, a port selection vector vₘ is a N₃-element column vector containing a value of 1 in element (m mod N₃) and zeros elsewhere (where the first element is element 0).

When N₃ value can be different across TRPs, for a given N_{3,r} value, a port selection vector vₘ_{ᵣ} is a N₃-element column vector containing a value of 1 in element (mᵣ mod N₃) and zeros elsewhere (where the first element is element 0).

In one embodiment, the FD bases (or FD basis vectors) used for W_{f} quantitation are limited within a single window/set with size N configured to the UE.

In one example, FD bases (or FD basis vectors) in the window are consecutive from an orthogonal DFT matrix.

In one example, FD bases (or FD basis vectors) in the set can be consecutive/non-consecutive, and are selected freely by NW from an orthogonal DFT matrix.

In the present disclosure, the term ‘polarization’ is used to indicate a group of CSI-RS antenna ports. For example, a first polarization can correspond to CSI-RS antenna ports

$$\{ 0 , 1 , … , \frac{{P}_{CSIRS}}{2} - 1 \}$$

and a second polarization can correspond to CSI-RS antenna ports

$$\{ \frac{{P}_{CSIRS}}{2} , … {P}_{CSIRS} - 1 \} .$$

The coefficients matrix W₂ across all TRPs can be determined based per TRP W_{2,r} matrices, where r=1, . . . , N_{TRP}. For example,
When W_{f} is TRP-common (one We common for all TRPs), then

$${W}_{2} = [ \begin{matrix}{W}_{2 , 1} \\ ⋮ \\ {W}_{2 , {N}_{TRP}}\end{matrix} ]$$

is the coefficient matrix across all TRPs.
When W_{f} is TRP-specific (one W_{f,r} for each TRP r), then

$${W}_{2} = [ \begin{matrix}{W}_{2 , 1} & 0 & 0 \\ 0 & ⋱ & 0 \\ 0 & 0 & {W}_{2 , {N}_{TRP}}\end{matrix} ]$$

is the coefficient matrix across all TRPs.

In one embodiment, a strongest coefficient indicator (SCI) is used to indicate the location (or index) of the strongest coefficient of the component W₂ across all TRPs. (The other coefficients are normalized by the coefficient of the SCI.) In one example, the SCI is common for all layers, i.e., one SCI is reported for all layers. In another example, the SCI is layer-specific, i.e., one SCI is reported for each layer value. The coefficient corresponding to the SCI is set to 1 (hence not reported).

The payload of the SCI can be according to one of the following examples.
In one example, the payload is ┌log₂(X)┐ bits.
   In one example, X=2 L (e.g., when L SD basis vectors are joint across TRPs).
   In one example,

$$X = 2 {\sum }_{r = 1}^{{N}_{TRP}} {L}_{r}$$

(e.g., which SD basis vectors are separate for each TRP, and each TRP can have different number of SD basis vectors).
In one example, X=2N_{TRP}L (e.g., when SD basis vectors are separate for each TRP, and each TRP has same number of SD basis vectors).
In one example, X=2 LM or 2LMᵥ (e.g., when L SD basis vectors and FD basis vectors are joint across TRPs).
In one example,

$$X = 2 {\sum }_{r = 1}^{{N}_{TRP}} {L}_{r} {M}_{r}$$

(e.g., when SD basis vectors and FD basis vectors are separate for each TRP, and each TRP can have different number of SD/FD basis vectors).
In one example,

$$X = 2 M {\sum }_{r = 1}^{{N}_{TRP}} {L}_{r} .$$

In one example,

$$X = 2 L {\sum }_{r = 1}^{{N}_{TRP}} {M}_{r} .$$

In one example,

$$X = 2 {\sum }_{r = 1}^{{N}_{TRP}} {L}_{r} {M}_{r} .$$

In one example, X=2N_{TRP}LM (e.g., when SD/FD basis vectors are separate for each TRP, and each TRP has same number of SD/FD basis vectors).
In one example, X=β2LM or β2LMᵥ (e.g., when L SD basis vectors and FD basis vectors are joint across TRPs).
In one example,

$$X = 2 β {\sum }_{r = 1}^{{N}_{TRP}} {L}_{r} {M}_{r}$$

(e.g., when SD basis vectors and FD basis vectors are separate for each TRP, and each TRP can have different number of SD/FD basis vectors).
In one example,

$$X = 2 M {\sum }_{r = 1}^{{N}_{TRP}} {L}_{r} .$$

In one example,

$$X = 2 L {\sum }_{r = 1}^{{N}_{TRP}} {M}_{r} .$$

In one example,

$$X = 2 β {\sum }_{r = 1}^{{N}_{TRP}} {L}_{r} {M}_{r} .$$

In one example, X=2N_{TRP}βLM (e.g., when SD/FD basis vectors are separate for each TRP, and each TRP has same number of SD/FD basis vectors).
In one example, the payload is ┌log₂ (X)┐+┌log₂ (Y)┐ bits, where ┌log₂ (X)┐ bits are used to indicate the index of the strongest coefficient and ┌log₂ (Y)┐ bits are used to indicate the index of the TRP the strongest coefficient belong to (e.g. strongest TRP).
   In one example, X=2 L and Y=N_{TRP}.
   In one example, X=2Lᵣ and Y=N_{TRP}·
   In one example, X=2 LM and Y=N_{TRP}
   In one example, X=2LᵣMᵣ and Y=N_{TRP}.
   In one example, X=β2LM and Y=N_{TRP}.
   In one example, X=β2LᵣMᵣ and Y=N_{TRP}.

Here, the SCI can implicitly indicate a strongest TRP. That is, the TRP index r* the strongest coefficient belongs to is also the strongest TRP.

In one example, a strongest TRP described in all embodiments/examples in this disclosure can be replaced by a reference TRP. In one example, a reference TRP can be configured via RRC, MAC-CE, or DCI. In one example, a reference TRP can be fixed or determined in a pre-defined rule. In one example, a reference TRP can be determined by UE and reported as a part of CSI.

In one example, the SCI comprises a pair of indicators (x, y), where the indicator x indicates the index of the strongest coefficient, and the indicator y indicates the index of the TRP the strongest coefficient belong to (e.g., y is a strongest TRP indicator).

In one example, there are two separate indicators (x, y), where the SCI corresponds to x and the strongest TRP indicator corresponds to y.

In one example, the payload of the indicator y is ┌log₂ (Y)┐ bits.

In one example, the payload of the indicator y is ┌log₂ (X)┐ bits.
In one example, X=2L.
In one example, X=2 Lᵣ.
In one example, X=2 LM.
In one example, X=2 LᵣMᵣ.
In one example, X=β2LM.
In one example, X=β2 LᵣMᵣ.

In Rel-16/17 Type-II codebook, amplitude quantization scheme for W₂ is in a differential manner, i.e., each amplitude value is computed as p⁽¹⁾p⁽²⁾ where p⁽¹⁾ is a reference amplitude value, and p⁽²⁾ is a (differential) coefficient amplitude value. There are two reference amplitude values

$${p}_{l}^{( 1 )} = [ \begin{matrix}{p}_{l , 0}^{( 1 )} & {p}_{l , 0}^{( 1 )}\end{matrix} ]$$

for layer l=1, . . . , v in [REF9] wherein one reference value corresponding to the SCI is set to 1 (hence not reported, i.e.,

$${k}_{l , ⌊ \frac{{i}_{l}^{*}}{L} ⌋}^{( 1 )} = 15 , {k}_{l , {i}_{l}^{*} , 0}^{( 2 )} = 7 , {k}_{l , {i}_{l}^{*} , 0}^{( 3 )} = 1 and {c}_{l , {i}_{l}^{*} , 0} = 0 ) ,$$

and the other reference value, which corresponds to the other polarization of the coefficient of the SCI, is selected from 4-bit amplitude codebook, Table 5.2.2.2.5-2 in [REF9], and is reported (i.e., the indicator

$${k}_{l , ( ⌊ \frac{{i}_{l}^{*}}{L} ⌋ + 1 ) mod 2}^{( 1 )}$$

is reported). For p⁽²⁾, please refer to [REF9] in detail.

In the mTRP codebook of the disclosure, for N_{TRP}≥2, the number of reference amplitude values (on p⁽¹⁾) can be according to at least one of the following examples.

$$Let {p}_{r , l}^{( 1 )} = [ \begin{matrix}{p}_{r , l , 0}^{( 1 )} & {p}_{r , l , 0}^{( 1 )}\end{matrix} ]$$

be the two reference amplitude values for TRP r∈{1, . . . , N_{TRP}} and layer l=1, . . . , v. N≤N_{TRP} can be configured via RRC, MAC-CE or DCI, or can be determined by UE and reported or can be determined implicitly, where N is the number of (selected) cooperating TRPs among N_{TRP} TRPS.

In one example, for each layer l (layer-specific), the number of reference amplitude values (N_{ref}) is fixed regardless of the value of N_{TRP} (or N). For example, N_{ref}=2. So, there are a total of 2v reference amplitude values for v layers.
In one example, similar to Rel-16/17 Type-II codebook, for each layer l, one reference value corresponding to the SCI is set to 1 for the polarization

$$( {x}^{*} = ⌊ \frac{{i}_{l}^{*}}{L} ⌋ )$$

### of the SCI for all TRPs, i.e.,

$${p}_{r , l , {x}^{*}}^{( 1 )} = 1$$

for all r values, and the other reference value for the other polarization (x≠x*) for all TRPs is selected from 4-bit amplitude codebook and is reported. So, the total payload is 4 bits per layer.
In one example, similar to Rel-16/17 Type-II codebook, for each layer l, one reference value corresponding to the SCI is set to 1 for the polarization

$$( {x}^{*} = ⌊ \frac{{i}_{l}^{*}}{L} ⌋ )$$

of the SCI for the strongest TRP, i.e.,

$${p}_{{r}^{*} , l , {x}^{*}}^{( 1 )} = 1$$

for the r* value associated with the strongest TRP, and the other reference value for the other polarization (x≠x*) for the strongest TRP is selected from 4-bit amplitude codebook and is reported. So, the total payload is 4 bits per layer.
In one example, similar to Rel-16/17 Type-II codebook, for each layer l, one reference value corresponding to the SCI is set to 1 for the polarization

$$( {x}^{*} = ⌊ \frac{{i}_{l}^{*}}{L} ⌋ )$$

of the SCI for the strongest TRP, i.e.,

$${p}_{{r}^{*} , l , {x}^{*}}^{( 1 )} = 1$$

for the r* value associated with the strongest TRP, and the other reference value for the remaining coefficients not associated with the polarization of the SCI for the strongest TRP (i.e., ∀(r, x)≠(r*, x*) is selected from 4-bit amplitude codebook and is reported. So, the total payload is 4 bits per layer.
In one example, for each layer l, one reference value corresponding to the SCI is set to 1 (hence no reported) for the polarization of the SCI for all TRPs. For each layer l, for the other polarization of the SCI, a second strongest coefficient indicator is used to indicate the location (or index) of the strongest coefficient of the W₂ across all TRPs (i.e., among a half of number of coefficients in W₂ for the other polarization of the SCI). The other reference value corresponding to the second SCI is selected from an x-bit amplitude codebook (e.g., x=4) and is reported. This reference value is for the other polarization of the SCI for all TRPs.

In one example, the number of reference amplitude values (N_{ref}) is fixed regardless of the value of N_{TRP} (or N). For example, N_{ref}=2, and the total number of reference amplitude values for v layers is 2 (layer-common).
In one example, for all layers, one reference value corresponding to the SCI is set to 1 for the polarization

$$( {x}^{*} = ⌊ \frac{{i}_{l}^{*}}{L} ⌋ )$$

### of the SCI for all TRPs, i.e.,

$${p}_{{r}^{*} , l , {x}^{*}}^{( 1 )} = 1$$

for all r values, and the other reference value for the other polarization (x≠x*) for all TRPs is selected from 4-bit amplitude codebook and is reported. So, the total payload is 4 bits for all layers.
In one example, similar to Rel-16/17 Type-II codebook, for all layers l, one reference value corresponding to the SCI is set to 1 for the polarization

$$( {x}^{*} = ⌊ \frac{{i}_{l}^{*}}{L} ⌋ )$$

of the SCI for the strongest TRP, i.e.,

$${p}_{{r}^{*} , l , {x}^{*}}^{( 1 )} = 1$$

for the r* value associated with the strongest TRP, and the other reference value for the other polarization (x≠x*) for the strongest TRP is selected from 4-bit amplitude codebook and is reported. So, the total payload is 4 bits for all layers.
In one example, similar to Rel-16/17 Type-II codebook, for all layers l, one reference value corresponding to the SCI is set to 1 for the polarization

$$( {x}^{*} = ⌊ \frac{{i}_{l}^{*}}{L} ⌋ )$$

of the SCI for the strongest TRP, i.e.,

$${p}_{{r}^{*} , l , {x}^{*}}^{( 1 )} = 1$$

for the r* value associated with the strongest TRP, and the other reference value for the remaining coefficients not associated with the polarization of the SCI for the strongest TRP (i.e., ∀(r, x)≠(r*, x*) is selected from 4-bit amplitude codebook and is reported. So, the total payload is 4 bits for all layers.
In one example, for all layers, one reference value corresponding to the SCI is set to 1 (hence no reported) for the polarization of the SCI for all TRPs. For all layers, for the other polarization of the SCI, a second strongest coefficient indicator is used to indicate the location (or index) of the strongest coefficient of the W₂ across all TRPs (i.e., among a half of number of coefficients in W₂ for the other polarization of the SCI). The other reference value corresponding to the second SCI is selected from an x-bit amplitude codebook (e.g., x=4) and is reported. This reference value is for the other polarization of the SCI for all TRPs.

In one example, for each layer l (layer-specific), the number of reference amplitude values (N_{ref}) is fixed regardless of the value of N_{TRP} (or N). For example, N_{ref}=3. So, there are a total of 3u reference amplitude values for v layers.
In one example, similar to Rel-16/17 Type-II codebook, for each layer l, one reference value corresponding to the SCI is set to 1 for the polarization

$$( {x}^{*} = ⌊ \frac{{i}_{l}^{*}}{L} ⌋ )$$

of the SCI for the strongest TRP, i.e.,

$${p}_{{r}^{*} , l , {x}^{*}}^{( 1 )} = 1$$

for the r* value associated with the strongest TRP, and another reference value for the other polarization (x≠x*) for the strongest TRP is selected from 4-bit amplitude codebook and is reported, and the other reference value for the remaining coefficients not associated with the strongest TRP is selected from 4-bit amplitude codebook and is reported. So, the total payload is 8 bits per layer.

In one example, the number of reference amplitude values (N_{ref}) is fixed regardless of the value of N_{TRP} (or N). For example, N_{ref}=3, and the total number of reference amplitude values for v layers is 3 (layer-common).
In one example, similar to Rel-16/17 Type-II codebook, for all layers, one reference value corresponding to the SCI is set to 1 for the polarization

$$( {x}^{*} = ⌊ \frac{{i}_{l}^{*}}{L} ⌋ )$$

of the SCI for the strongest TRP, i.e.,

$${p}_{{r}^{*} , l , {x}^{*}}^{( 1 )} = 1$$

for the r* value associated with the strongest TRP, and another other reference value for the other polarization (x≠x*) for the strongest TRP is selected from 4-bit amplitude codebook and is reported, and the other reference value for the remaining coefficients not associated with the strongest TRP is selected from 4-bit amplitude codebook and is reported. So, the total payload is 8 bits for all layers.

In one example, for each layer l (layer-specific), the number of reference amplitude values (N_{ref}) is fixed regardless of the value of N_{TRP} (or N). For example, N_{ref}=4. So, there are a total of 4v reference amplitude values for u layers.
In one example, similar to Rel-16/17 Type-II codebook, for each layer l, one reference value corresponding to the SCI is set to 1 for the polarization

$$( {x}^{*} = ⌊ \frac{{i}_{l}^{*}}{L} ⌋ )$$

of the SCI for the strongest TRP, i.e.,

$${p}_{{r}^{*} , l , {x}^{*}}^{( 1 )} = 1$$

for the r* value associated with the strongest TRP, and a second reference value for the other polarization (x≠x*) for the strongest TRP is selected from 4-bit amplitude codebook and is reported, and a third reference value for the remaining coefficients for the TRPs not associated with the strongest TRP for the polarization of the SCI is selected from 4-bit amplitude codebook and is reported, and a fourth reference value for the remaining coefficients for the TRPs not associated with the strongest TRP for the other polarization of the SCI is selected from 4-bit amplitude codebook and is reported. So, the total payload is 12 bits per layer.

In one example, the number of reference amplitude values (N_{ref}) is fixed regardless of the value of N_{TRP} (or N). For example, N_{ref}=4, and the total number of reference amplitude values for v layers is 4 (layer-common).

In one example, similar to Rel-16/17 Type-II codebook, for all layers, one reference value corresponding to the SCI is set to 1 for the polarization

$$( {x}^{*} = ⌊ \frac{{i}_{l}^{*}}{L} ⌋ )$$

of the Sei for the strongest TRP, i.e.,

$${p}_{{r}^{*} , l , {x}^{*}}^{( 1 )} = 1$$

for the r* value associated with the strongest TRP, and a second reference value for the other polarization (x≠x*) for the strongest TRP is selected from 4-bit amplitude codebook and is reported, and a third reference value for the remaining coefficients for the TRPs not associated with the strongest TRP for the polarization of the SCI is selected from 4-bit amplitude codebook and is reported, and a fourth reference value for the remaining coefficients for the TRPs not associated with the strongest TRP for the other polarization of the SCI is selected from 4-bit amplitude codebook and is reported. So, the total payload is 12 bits for all layers.

In one example, for each of the above examples, equal-bit codebook (e.g., 4-bit) can be used for reference amplitude values.

In another example, for each of the above examples, unequal-bit codebook (e.g., 4-bit) can be used for reference amplitude values.
For example, for a reference amplitude value associated with a strongest TRP, 4-bit amplitude codebook is used, and for a reference amplitude value associated a weaker TRP, 3-bit amplitude codebook is used. The unequal-bit can be signaled by NW via RRC, MAC-CE, or DCI.

In one example, for each layer l (layer-specific), the number N_{ref} of reference amplitude values is 2N_{TRP} (or 2N). We can replace N_{TRP} by N in the examples below.
In one example, one reference value corresponding to the SCI is set to 1 (hence not reported) for the polarization of the SCI for the TRP associated with the SCI, and another reference value is for the other polarization for the TRP associated with the SCI, is selected from an x-bit amplitude codebook (e.g., x=4), and is reported. Each of the remaining 2N_{TRP}−2 reference values is a reference amplitude value for each polarization for each of the other (N_{TRP}−1) TRPs that are not associated with the SCI. The reference amplitude value is selected from an y-bit amplitude codebook (e.g., y=4, or y=3), and is reported. In one example, x,y can be the same value (x=y), fixed or configured by NW.
In one example, one reference value corresponding to the SCI is set to 1 (hence not reported) for the polarization of the SCI for the TRP associated with the SCI. For the other polarization, a second strongest coefficient indicator is used to indicate the location (or index) of the strongest coefficient of the W₂ across all TRPs (i.e., among a half of number of coefficients in W₂ for the other polarization of the SCI). Another reference value corresponding to the second SCI is selected from an x-bit amplitude codebook (e.g., x=4) and is reported. In one example, the second SCI is common for all layers i.e., one second-SCI is reported for all layers. In another example, the second-SCI is layer-specific, i.e., one second-SCI is reported for each layer value. In one example, the other 2N_{TRP}−2 remaining reference values are partitioned into two groups, wherein group 1 is for the polarization of the SCI for each of the (N_{TRP}−1) TRPs not associated with the SCI, and group 2 is for the other polarization of the SCI for each of the (N_{TRP}−1) TRPs not associated with the SCI. For the reference values in group 1, each reference value is selected from an y₁-bit amplitude codebook. For the reference values in group 2, each reference value is selected from an y₂-bit amplitude codebook. In one example, each reference value in group 2 is a second-level reference value, i.e., each corresponding resultant reference value is computed as the product of the second-level reference value and the reference value for the other polarization of the SCI for the TRP associated with the SCI. In one example, x, y₁, y₂ can be the same value, fixed or configured by NW.

In one example, for all layers (layer-common), the number N_{ref} of reference amplitude values is 2N_{TRP} (or 2N). The above examples herein can be the examples for all layers, instead of each layer.

In one example, for each layer l (layer-specific), the number N_{ref} of reference amplitude values is 2+ (N_{TRP}−1) (or 2+ (N−1)). We can replace N_{TRP} by N in the examples below.
In one example, one reference value corresponding to the SCI is set to 1 (hence not reported) for the polarization of the SCI for the TRP associated with the SCI, and another reference value is for the other polarization of the SCI for the TRP associated with the SCI, is selected from an x-bit amplitude codebook (e.g., x=4), and is reported. Each of the remaining N_{TRP}−1 reference values is a reference amplitude value for both the polarizations for each of the other (N_{TRP}−1) TRPs not associated with the SCI. The reference amplitude value is selected from an y-bit amplitude codebook (e.g., y=4, or y=3), and is reported. In one example, x,y can be the same value, fixed or configured by NW.

In one example, for all layers (layer-common), the number N_{ref} of reference amplitude values is 2+ (N_{TRP}−1) (or 2+ (N−1)). The above examples herein can be the examples for all layers, instead of each layer.

In one example, for each layer l (layer-specific), the number N_{ref} of reference amplitude values is N_{TRP} (or N). We can replace N_{TRP} by N in the examples below.
In one example, one reference value corresponding to the SCI is set to 1 (hence not reported) for the both polarizations for the TRP associated with the SCI, and each of the remaining N_{TRP}−1 reference value is for the both polarizations for each of the N_{TRP}−1 TRPs not associated with the SCI, is selected from an x-bit amplitude codebook (e.g., x=4), and is reported. Each of the remaining N_{TRP}−1 reference values is a reference amplitude value for both the polarizations for each of the other (N_{TRP}−1) TRPs not associated with the SCI. The reference amplitude value is selected from an y-bit amplitude codebook (e.g., y=4, or y=3), and is reported. In one example, x, y can be the same value, fixed or configured by NW.

In one example, for all layers (layer-common), the number N_{ref} of reference amplitude values is N_{TRP}. The above examples herein can be the examples for all layers, instead of each layer.

In one example, for each layer l (layer-specific), the number N_{ref} of reference amplitude values is N_{TRP}-specific (or N-specific). We can replace N_{TRP} by N in the examples below.
In one example, N_{ref}=a for N_{TRP}≤b, and N_{ref}=C for N_{TRP}>b, e.g., a=2, b=3, c=4.

In one example, for all layers (layer-common), the number N_{ref} of reference amplitude values is N_{TRP}-specific. The above examples herein can be the examples for all layers, instead of each layer.

In these examples, each reference amplitude can be associated with a group of coefficients (comprising W2). So, if the number of reference amplitudes is X, then there are X groups of coefficients, and a reference amplitude is associated with each group.

In one example, for each layer l (layer-specific), the number N_{ref} of reference amplitude values is configured by NW (i.e., one value of N_{ref} for each layer). In one example, N_{TRP} is replaced with N in the examples below and other examples in this disclosure.
In one example, N_{ref}={2, 2N_{TRP}} and one of the values is configured via DCI, MAC-CE, or RRC parameter. Once one value (x) is configured, reference amplitude values (and corresponding grouping of coefficients) can be according to one of the above examples for the case of N_{ref}=X.
In one example, N_{ref}={2, 2+N_{TRP}−1} and one of the values is configured via DCI, MAC-CE, or RRC parameter. Once one value (x) is configured, reference amplitude values (and corresponding grouping of coefficients) can be according to one of the above examples for the case of N_{ref}=X.
In one example, N_{ref}={2, N_{TRP}} and one of the values is configured via DCI, MAC-CE, or RRC parameter. Once one value (x) is configured, reference amplitude values (and corresponding grouping of coefficients) can be according to one of the above examples for the case of N_{ref}=X.
In one example, N_{ref}={2, N_{TRP}, 2N_{TRP}} and one of the values is configured via DCI, MAC-CE, or RRC parameter. Once one value (x) is configured, reference amplitude values (and corresponding grouping of coefficients) can be according to one of the above examples for the case of N_{ref}=X.
In one example, N_{ref}={2,2+N_{TRP}−1,2N_{TRP}} and one of the values is configured via DCI, MAC-CE, or RRC parameter. Once one value (x) is configured, reference amplitude values (and corresponding grouping of coefficients) can be according to one of the above examples for the case of N_{ref}=X.
In one example, any subset of {2,3,4, N_{TRP}, 2N_{TRP}, 2+N_{TRP}−1} can be a set for N_{ref}, and one of the values is configured via DCI, MAC-CE, or RRC parameter. Once one value (x) is configured, reference amplitude values (and corresponding grouping of coefficients) can be according to one of the above examples for the case of N_{ref}=x.
In one example, N_{ref}={2,3} and one of the values is configured via DCI, MAC-CE, or RRC parameter. Once one value (x) is configured, reference amplitude values (and corresponding grouping of coefficients) can be according to one of the above examples for the case of N_{ref}=X.
In one example, N_{ref}={2,3,4} and one of the values is configured via DCI, MAC-CE, or RRC parameter. Once one value (x) is configured, reference amplitude values (and corresponding grouping of coefficients) can be according to one of the above examples for the case of N_{ref}=X.
In one example, N_{ref}={2,4} and one of the values is configured via DCI, MAC-CE, or RRC parameter. Once one value (x) is configured, reference amplitude values (and corresponding grouping of coefficients) can be according to one of the above examples for the case of N_{ref}=X.
In one example, N_{ref}={2,4, . . . , 2N_{TRP}} and one of the values is configured via DCI, MAC-CE, or RRC parameter. Once one value (x) is configured, reference amplitude values (and corresponding grouping of coefficients) can be according to one of the above examples for the case of N_{ref}=X.
In one example, N_{ref}={2,3,4, . . . , N_{TRP}} and one of the values is configured via DCI, MAC-CE, or RRC parameter. Once one value (x) is configured, reference amplitude values (and corresponding grouping of coefficients) can be according to one of the above examples for the case of N_{ref}=X.
In one example, N_{ref}={4,2N_{TRP}} and one of the values is configured via DCI, MAC-CE, or RRC parameter. Once one value (x) is configured, reference amplitude values (and corresponding grouping of coefficients) can be according to one of the above examples for the case of N_{ref}=X.
In one example, N_{ref}={2,4,2N_{TRP}} and one of the values is configured via DCI, MAC-CE, or RRC parameter. Once one value (x) is configured, reference amplitude values (and corresponding grouping of coefficients) can be according to one of the above examples for the case of N_{ref}=X.

In one example, N_{ref}>2 is configured only when N_{TRP}>1 is configured. That is, when N_{TRP}=1, N_{ref} is fixed to 2 (legacy Rel-16 codebook), and when N_{TRP}>1, N_{ref} is configured from a set of values(S) via DCI, MAC-CE, or RRC. For example, S can be one of the sets described in the examples herein. For example, S=[2,3], S=[2,3,4], S=[2,4], S=[2,2N_{TRP}], S=[2, N_{TRP}], or . . . .

In one example, for all layers (layer-common), the number N_{ref} of reference amplitude values is configured by NW (i.e., one value of N_{ref} for all layers). The above examples herein can be the examples for all layers, instead of each layer.

In one example, for each layer l (layer-specific), the number N_{ref} of reference amplitude values is determined by UE and reported (i.e., one value of N_{ref} for each layer). We can replace N_{TRP} by N in the examples below.
In one example, N_{ref}={2, 2N_{TRP}} and one of the values is determined and reported. Once one value (x) is determined, reference amplitude values (and corresponding grouping of coefficients) can be according to one of the above examples for the case of N_{ref}=X.
In one example, N_{ref}={2, 2+N_{TRP}−1} and one of the values is determined and reported. Once one value (x) is determined, reference amplitude values (and corresponding grouping of coefficients) can be according to one of the above examples for the case of N_{ref}=x.
In one example, N_{ref}={2, N_{TRP}} and one of the values is determined and reported. Once one value (x) is determined, reference amplitude values (and corresponding grouping of coefficients) can be according to one of the above examples for the case of N_{ref}=X.
In one example, N_{ref}={2, N_{TRP}, 2N_{TRP}} and one of the values is determined and reported. Once one value (x) is determined, reference amplitude values (and corresponding grouping of coefficients) can be according to one of the above examples for the case of N_{ref}=X.
In one example, N_{ref}={2,2+N_{TRP}−1,2N_{TRP}} and one of the values is determined and reported. Once one value (x) is determined, reference amplitude values (and corresponding grouping of coefficients) can be according to one of the above examples for the case of N_{ref}=X.
In one example, any subset of {2,3,4, N_{TRP}, 2N_{TRP}, 2+N_{TRP}−1} can be a set for N_{ref}, and one of the values is determined and reported. Once one value (x) is determined, reference amplitude values (and corresponding grouping of coefficients) can be according to one of the above examples for the case of N_{ref}=X.
In one example, N_{ref}={2,3} and one of the values is determined and reported. Once one value (x) is determined, reference amplitude values (and corresponding grouping of coefficients) can be according to one of the above examples for the case of N_{ref}=X.
In one example, N_{ref}={2,3,4} and one of the values is determined and reported. Once one value (x) is determined, reference amplitude values (and corresponding grouping of coefficients) can be according to one of the above examples for the case of N_{ref}=X.
In one example, N_{ref}={2,4} and one of the values is determined and reported. Once one value (x) is determined, reference amplitude values (and corresponding grouping of coefficients) can be according to one of the above examples for the case of N_{ref}=X.
In one example, N_{ref}={2,4, . . . , 2N_{TRP}} and one of the values is determined and reported. Once one value (x) is determined, reference amplitude values (and corresponding grouping of coefficients) can be according to one of the above examples for the case of N_{ref}=X.
In one example, N_{ref}={2,3,4, . . . , N_{TRP}} and one of the values is determined and reported. Once one value (x) is determined, reference amplitude values (and corresponding grouping of coefficients) can be according to one of the above examples for the case of N_{ref}=X.
In one example, N_{ref}={4,2N_{TRP}} and one of the values is determined and reported. Once one value (x) is determined, reference amplitude values (and corresponding grouping of coefficients) can be according to one of the above examples for the case of N_{ref}=X.
In one example, N_{ref}={2,4,2N_{TRP}} and one of the values is determined and reported. Once one value (x) is determined, reference amplitude values (and corresponding grouping of coefficients) can be according to one of the above examples for the case of N_{ref}=X.

In one example, N_{ref}>2 is configured only when N_{TRP}>1 is configured. That is, when N_{TRP}=1, N_{ref} is fixed to 2 (legacy Rel-16 codebook), and when N_{TRP}>1, N_{ref} is determined and reported from a set of values(S). For example, S can be one of the sets described in the examples herein. For example, S=[2,3], S=[2,3,4], S=[2,4], S=[2,2N_{TRP}], S=[2, N_{TRP}], or . . . .

In one example, for all layers (layer-common), the number N_{ref} of reference amplitude values is determined by UE and reported (i.e., one value of N_{ref} for all layers). The above examples herein can be the examples for all layers, instead of each layer.

In one example, for each of the above examples, equal-bit codebook (e.g., 3, 4-bit) can be used for reference amplitude values.

In another example, for each of the above examples, unequal-bit codebook (e.g., 2, 3, 4-bit) can be used for reference amplitude values.
In one embodiment, a UE is configured/indicated with G≥1 TRP groups, wherein each TRP group include one or more TRPs. Or the UE can be configured to determine G≥1 TRP groups among N_{TRP} (or N) TRPs and to report the G TRP groups. Or TRP groups can be implicitly determined without signaling/reporting. Or TRP groups are fixed, e.g., based on TRP indices, i.e., TRP group includes TRP #1 . . . . TRP #n₁, TRP group includes TRP #n₁+1 . . . . TRP #(n₁+n₂) and so on where N≤N_{TRP}.
In one example, when G=2, TRP group 1 includes one TRP, and TRP group 2 includes three TRPs for the case when N_{TRP}=4 or when the number of co-operating TRPs N=4, where N≤N_{TRP}.
In one example, when G=2, TRP group 1 includes two TRPs, and TRP group 2 includes one TRP for the case of N_{TRP}=3 or when the number of co-operating TRPs N=3, where N≤N_{TRP}.

In one example, when G=2, TRP group 1 includes two TRPs, and TRP group 2 includes two TRPs for the case of N_{TRP}=4 or when the number of co-operating TRPs N=4, where N≤N_{TRP}.

In one example, when G=2, TRP group 1 includes three TRPs, and TRP group 2 includes one TRP for the case of N_{TRP}=4 or when the number of co-operating TRPs N=4, where N≤N_{TRP}.

In one example, the value of G is fixed (e.g., to 2). In one example, the value of G is configured (e.g., via RRC). In one example, the value of G is reported by the UE (e.g., as part of the CSI report).
In one example, when G=2, TRP group 1 includes one TRP, and TRP group 2 includes one TRP for the case when N_{TRP}=2 or when the number of co-operating TRPs N=2, where N≤N_{TRP}.
In one example, when G=2, TRP group 1 includes one TRP, and TRP group 2 includes two TRPs for the case when N_{TRP}=3 or when the number of co-operating TRPs N=3, example, when G=3, TRP group 1 includes two TRPs, TRP group 2 includes one TRP, and TRP group 3 includes one TRP for the case of N_{TRP}=4 or when the number of co-operating TRPs N=4, where N≤N_{TRP}.

When G=2, a

$$⌈ {log}_{2} ( \begin{matrix}N \\ {n}_{1}\end{matrix} ) ⌉$$

bit indicator (e.g., a PMI component or a CRI component) can be used to indicate the TRPs comprising the TRP group 1.

In one example, for each layer l (layer-specific), the number of reference amplitude values (N_{ref}) is fixed regardless of the value of G. For example, N_{ref}=2. So, there are a total of 2v reference amplitude values for v layers.
In one example, similar to Rel-16/17 Type-II codebook, for each layer l, one reference value corresponding to the SCI is set to 1 for the polarization

$$( {x}^{*} = ⌊ \frac{{i}_{l}^{*}}{L} ⌋ )$$

of the SCI for all TRP groups, i.e.,

$${p}_{g , l , {x}^{⋆}}^{( 1 )} = 1$$

for all g values, and the other reference value for the other polarization (x≠x*) for all TRP groups is selected from 4-bit amplitude codebook and is reported. So, the total payload is 4 bits per layer.
In one example, similar to Rel-16/17 Type-II codebook, for each layer l, one reference value corresponding to the SCI is set to 1 for the polarization

$$( {x}^{*} = ⌊ \frac{{i}_{l}^{*}}{L} ⌋ )$$

of the SCI for the strongest TRP group, i.e.,

$${p}_{{g}^{*} , l , {x}^{⋆}}^{( 1 )} = 1$$

for the g value associated with the strongest TRP group, and the other reference value for the other polarization (x≠x*) for the strongest TRP group is selected from 4-bit amplitude codebook and is reported. So, the total payload is 4 bits per layer.
In one example, similar to Rel-16/17 Type-II codebook, for each layer l, one reference value corresponding to the SCI is set to 1 for the polarization

$$( {x}^{*} = ⌊ \frac{{i}_{l}^{*}}{L} ⌋ )$$

of the SCI for the strongest TRP group, i.e.,

$${p}_{{g}^{*} , l , {x}^{⋆}}^{( 1 )} = 1$$

for the g* value associated with the strongest TRP group, and the other reference value for the remaining coefficients not associated with the polarization of the SCI for the strongest TRP group (i.e., ∀(g, x)≠(g*, x*) is selected from 4-bit amplitude codebook and is reported. So, the total payload is 4 bits per layer.
In one example, for each layer l, one reference value corresponding to the SCI is set to 1 (hence no reported) for the polarization of the SCI for all TRP groups. For each layer l, for the other polarization of the SCI, a second strongest coefficient indicator is used to indicate the location (or index) of the strongest coefficient of the W₂ across all TRP groups (i.e., among a half of number of coefficients in W₂ for the other polarization of the SCI). In one example, the other reference value corresponding to the second SCI is selected from an x-bit amplitude codebook (e.g., x=4) and is reported. This reference value is for the other polarization of the SCI for all TRP groups.

In one example, the number of reference amplitude values (N_{ref}) is fixed regardless of the value of G. For example, N_{ref}=2, and the total number of reference amplitude values for v layers is 2 (layer-common). The examples herein can be the example for all layers, instead of each layer.

In one example, for each layer l (layer-specific), the number of reference amplitude values (N_{ref}) is fixed regardless of the value of G. For example, N_{ref}=3. So, there are a total of 3v reference amplitude values for v layers.
In one example, similar to Rel-16/17 Type-II codebook, for each layer l, one reference value corresponding to the SCI is set to 1 for the polarization

$$( {x}^{*} = ⌊ \frac{{i}_{l}^{*}}{L} ⌋ )$$

of the SCI for the strongest TRP group, i.e.,

$${p}_{{g}^{*} , l , {x}^{⋆}}^{( 1 )} = 1$$

for the g value associated with the strongest TRP group, and another other reference value for the other polarization (x≠x*) for the strongest TRP group is selected from 4-bit amplitude codebook and is reported, and the other reference value for the remaining coefficients not associated with the strongest TRP group is selected from 4-bit amplitude codebook and is reported. So, the total payload is 8 bits per layer.

In one example, the number of reference amplitude values (N_{ref}) is fixed regardless of the value of G. For example, N_{ref}=3, and the total number of reference amplitude values for v layers is 3 (layer-common). The examples herein can be the example for all layers, instead of each layer.

In one example, for each layer l (layer-specific), the number of reference amplitude values (N_{ref}) is fixed regardless of the value of G. For example, N_{ref}=4. So, there are a total of 4v reference amplitude values for v layers.
In one example, similar to Rel-16/17 Type-II codebook, for each layer l, one reference value corresponding to the SCI is set to 1 for the polarization

$$( {x}^{*} = ⌊ \frac{{i}_{l}^{*}}{L} ⌋ )$$

of the SCI for the strongest TRP group, i.e.,

$${p}_{{g}^{*} , l , {x}^{⋆}}^{( 1 )} = 1$$

for the g* value associated with the strongest TRP group, and a second reference value for the other polarization (x≠x*) for the strongest TRP group is selected from 4-bit amplitude codebook and is reported, and a third reference value for the remaining coefficients for the TRP groups not associated with the strongest TRP group for the polarization of the SCI is selected from 4-bit amplitude codebook and is reported, and a fourth reference value for the remaining coefficients for the TRP groups not associated with the strongest TRP group for the other polarization of the SCI is selected from 4-bit amplitude codebook and is reported. So, the total payload is 12 bits per layer.

In one example, for each layer l (layer-specific), the number of reference amplitude values (N_{ref}) is fixed regardless of the value of G. For example, N_{ref}=4. So, there are a total of 4v reference amplitude values for v layers. The examples herein can be the example for all layers, instead of each layer.

In one example, for each layer l (layer-specific), the number N_{ref} of reference amplitude values is 2G.
In one example, one reference value corresponding to the SCI is set to 1 (hence not reported) for the polarization of the SCI for the TRP group associated with the SCI, and another reference value is for the other polarization for the TRP group associated with the SCI, is selected from an x-bit amplitude codebook (e.g., x=4), and is reported. Each of the remaining 2G−2 reference values is a reference amplitude value for each polarization for each of the other (G−1) TRP groups that are not associated with the SCI. The reference amplitude value is selected from an y-bit amplitude codebook (e.g., y=4, or y=3), and is reported. In one example, x,y can be the same value (x=y), fixed or configured by NW.
In one example, one reference value corresponding to the SCI is set to 1 (hence no reported) for the polarization of the SCI for the TRP group associated with the SCI. For the other polarization, a second strongest coefficient indicator is used to indicate the location (or index) of the strongest coefficient of the W₂ across all TRP groups (i.e., among a half of number of coefficients in W₂ for the other polarization of the SCI). Another reference value corresponding to the second SCI is selected from an x-bit amplitude codebook (e.g., x=4) and is reported. In one example, the second SCI is common for all layers i.e., one second-SCI is reported for all layers. In another example, the second-SCI is layer-specific, i.e., one second-SCI is reported for each layer value. In one example, the other 2G−2 remaining reference values are partitioned into two groups, wherein group 1 is for the polarization of the SCI for each of the (G−1) TRP groups not associated with the SCI, and group 2 is for the other polarization of the SCI for each of the (G−1) TRP groups not associated with the SCI. For the reference values in group 1, each reference value is selected from an y₁-bit amplitude codebook. For the reference values in group 2, each reference value is selected from an y₂-bit amplitude codebook. In one example, each reference value in group 2 is a second-level reference value, i.e., each corresponding resultant reference value is computed as the product of the second-level reference value and the reference value for the other polarization of the SCI for the TRP group associated with the SCI. In one example, x, y₁, y₂ can be the same value, fixed or configured by NW.

In one example, for all layers (layer-common), the number N_{ref} of reference amplitude values is 2G. The above examples can be the examples for all layers. The examples herein can be the example for all layers, instead of each layer.

In one example, for each layer l (layer-specific), the number N_{ref} of reference amplitude values is 2+ (G−1).
In one example, one reference value corresponding to the SCI is set to 1 (hence not reported) for the polarization of the SCI for the TRP group associated with the SCI, and another reference value is for the other polarization of the SCI for the TRP group associated with the SCI, is selected from an x-bit amplitude codebook (e.g., x=4), and is reported. Each of the remaining G−1 reference values is a reference amplitude value for both the polarizations for each of the other (G−1) TRP groups not associated with the SCI. The reference amplitude value is selected from an y-bit amplitude codebook (e.g., y=4, or y=3), and is reported. In one example, x,y can be the same value, fixed or configured by NW.

In one example, for all layers (layer-common), the number N_{ref} of reference amplitude values is 2+ (G−1). The above examples can be the examples for all layers. The examples herein can be the example for all layers, instead of each layer.

In one example, for each layer l (layer-specific), the number N_{ref} of reference amplitude values is G.
In one example, one reference value corresponding to the SCI is set to 1 (hence not reported) for the both polarizations for the TRP group associated with the SCI, and each of the remaining G−1 reference value is for the both polarizations for each of the G−1 TRP groups not associated with the SCI, is selected from an x-bit amplitude codebook (e.g., x=4), and is reported. Each of the remaining G−1 reference values is a reference amplitude value for both the polarizations for each of the other (G−1) TRP groups not associated with the SCI. The reference amplitude value is selected from an y-bit amplitude codebook (e.g., y=4, or y=3), and is reported. In one example, x, y can be the same value, fixed or configured by NW.

In one example, for all layers (layer-common), the number N_{ref} of reference amplitude values is G. The above examples can be the examples for all layers. The examples herein can be the example for all layers, instead of each layer.

In one example, for each layer l (layer-specific), the number N_{ref} of reference amplitude values is G-specific.
In one example, N_{ref}=a for G≤b, and N_{ref}=c for G>b, e.g., a=2, b=1, c=4.

In one example, for all layers (layer-common), the number N_{ref} of reference amplitude values is G-specific. The above examples can be the examples for all layers. The examples herein can be the example for all layers, instead of each layer.

In these examples, each reference amplitude can be associated with a group of coefficients (comprising W₂). So, if the number of reference amplitudes is X, then there are X groups of coefficients, and a reference amplitude is associated with each group.

In one example, for each layer l (layer-specific), the number N_{ref} of reference amplitude values is configured by NW (i.e., one value of N_{ref} for each layer).
In one example, N_{ref}={2,2G} and one of the values is configured via DCI, MAC-CE, or RRC parameter. Once one value (x) is configured, reference amplitude values (and corresponding grouping of coefficients) can be according to one of the above examples for the case of N_{ref}=X.
In one example, N_{ref}={2,2+G−1} and one of the values is configured via DCI, MAC-CE, or RRC parameter. Once one value (x) is configured, reference amplitude values (and corresponding grouping of coefficients) can be according to one of the above examples for the case of N_{ref}=X.
In one example, N_{ref}={2, G} and one of the values is configured via DCI, MAC-CE, or RRC parameter. Once one value (x) is configured, reference amplitude values (and corresponding grouping of coefficients) can be according to one of the above examples for the case of N_{ref}=X.
In one example, N_{ref}={2, G, 2G} and one of the values is configured via DCI, MAC-CE, or RRC parameter. Once one value (x) is configured, reference amplitude values (and corresponding grouping of coefficients) can be according to one of the above examples for the case of N_{ref}=X.
In one example, N_{ref}={2,2+G−1,2G} and one of the values is configured via DCI, MAC-CE, or RRC parameter. Once one value (x) is configured, reference amplitude values (and corresponding grouping of coefficients) can be according to one of the above examples for the case of N_{ref}=X.
In one example, any subset of {2,3, G, 2G, 2+G−1} can be a set for N_{ref}, and one of the values is configured via DCI, MAC-CE, or RRC parameter. Once one value (x) is configured, reference amplitude values (and corresponding grouping of coefficients) can be according to one of the above examples for the case of N_{ref}=X.
In one example, N_{ref}={2,3} and one of the values is configured via DCI, MAC-CE, or RRC parameter. Once one value (x) is configured, reference amplitude values (and corresponding grouping of coefficients) can be according to one of the above examples for the case of N_{ref}=X.
In one example, N_{ref}={2,3,4} and one of the values is configured via DCI, MAC-CE, or RRC parameter. Once one value (x) is configured, reference amplitude values (and corresponding grouping of coefficients) can be according to one of the above examples for the case of N_{ref}=X.
In one example, N_{ref}={2,4} and one of the values is configured via DCI, MAC-CE, or RRC parameter. Once one value (x) is configured, reference amplitude values (and corresponding grouping of coefficients) can be according to one of the above examples for the case of N_{ref}=X.
In one example, N_{ref}={2,4, . . . , 2G} and one of the values is configured via DCI, MAC-CE, or RRC parameter. Once one value (x) is configured, reference amplitude values (and corresponding grouping of coefficients) can be according to one of the above examples for the case of N_{ref}=X.
In one example, N_{ref}={2,3,4, . . . , G} and one of the values is configured via DCI, MAC-CE, or RRC parameter. Once one value (x) is configured, reference amplitude values (and corresponding grouping of coefficients) can be according to one of the above examples for the case of N_{ref}=X.
In one example, N_{ref}={4,2G} and one of the values is configured via DCI, MAC-CE, or RRC parameter. Once one value (x) is configured, reference amplitude values (and corresponding grouping of coefficients) can be according to one of the above examples for the case of N_{ref}=x.
In one example, N_{ref}={2,4,2G} and one of the values is configured via DCI, MAC-CE, or RRC parameter. Once one value (x) is configured, reference amplitude values (and corresponding grouping of coefficients) can be according to one of the above examples for the case of N_{ref}=X.

In one example, N_{ref}>2 is configured only when G>1 is configured. That is, when N_{TRP}=1, N_{ref} is fixed to 2 (legacy Rel-16 codebook), and when G>1, N_{ref} is configured from a set of values(S) via DCI, MAC-CE, or RRC. For example, S can be one of the sets described in the examples herein. For example, S=[2,3], S=[2,3,4], S=[2,4], S=[2,2G], S=[2, G].

In one example, for all layers (layer-common), the number N_{ref} of reference amplitude values is configured by NW (i.e., one value of N_{ref} for all layers). The above examples can be the examples for all layers. The examples herein can be the example for all layers, instead of each layer.

In one example, for each layer l (layer-specific), the number N_{ref} of reference amplitude values is determined by UE and reported (i.e., one value of N_{ref} for each layer).
In one example, N_{ref}={2,2G} and one of the values is determined and reported. Once one value (x) is determined, reference amplitude values (and corresponding grouping of coefficients) can be according to one of the above examples for the case of N_{ref}=X.
In one example, N_{ref}={2,2+G−1} and one of the values is determined and reported. Once one value (x) is determined, reference amplitude values (and corresponding grouping of coefficients) can be according to one of the above examples for the case of N_{ref}=X.
In one example, N_{ref}={2, G} and one of the values is determined and reported. Once one value (x) is determined, reference amplitude values (and corresponding grouping of coefficients) can be according to one of the above examples for the case of N_{ref}=X.
In one example, N_{ref}={2, G, 2G} and one of the values is determined and reported. Once one value (x) is determined, reference amplitude values (and corresponding grouping of coefficients) can be according to one of the above examples for the case of N_{ref}=X.
In one example, N_{ref}={2,2+G−1,2G} and one of the values is determined and reported. Once one value (x) is determined, reference amplitude values (and corresponding grouping of coefficients) can be according to one of the above examples for the case of N_{ref}=x.
In one example, any subset of {2,3, G, 2G, 2+G−1} can be a set for N_{ref}, and one of the values is determined and reported. Once one value (x) is determined, reference amplitude values (and corresponding grouping of coefficients) can be according to one of the above examples for the case of N_{ref}=X.
In one example, N_{ref}={2,3} and one of the values is determined and reported. Once one value (x) is determined, reference amplitude values (and corresponding grouping of coefficients) can be according to one of the above examples for the case of N_{ref}=X.
In one example, N_{ref}={2,3,4} and one of the values is determined and reported. Once one value (x) is determined, reference amplitude values (and corresponding grouping of coefficients) can be according to one of the above examples for the case of N_{ref}=x.
In one example, N_{ref}={2,4} and one of the values is determined and reported. Once one value (x) is determined, reference amplitude values (and corresponding grouping of coefficients) can be according to one of the above examples for the case of N_{ref}=X.
In one example, N_{ref}={2,4, . . . , 2G} and one of the values is determined and reported. Once one value (x) is determined, reference amplitude values (and corresponding grouping of coefficients) can be according to one of the above examples for the case of N_{ref}=X.
In one example, N_{ref}={2,3,4, . . . , G} and one of the values is determined and reported. Once one value (x) is determined, reference amplitude values (and corresponding grouping of coefficients) can be according to one of the above examples for the case of N_{ref}=X.
In one example, N_{ref}={4,2G} and one of the values is determined and reported. Once one value (x) is determined, reference amplitude values (and corresponding grouping of coefficients) can be according to one of the above examples for the case of N_{ref}=X.
In one example, N_{ref}={2,4, G} and one of the values is determined and reported. Once one value (x) is determined, reference amplitude values (and corresponding grouping of coefficients) can be according to one of the above examples for the case of N_{ref}=X.

In one example, N_{ref}>2 is configured only when N_{TRP}>1 is configured. That is, when N_{TRP}=1, N_{ref} is fixed to 2 (legacy Rel-16 codebook), and when N_{TRP}>1, N_{ref} is determined and reported from a set of values(S). For example, S can be one of the sets described in the examples herein. For example, S=[2,3], S=[2,3,4], S=[2,4], S=[2,2N_{TRP}], S=[2, N_{TRP}].

In one example, for all layers (layer-common), the number N_{ref} of reference amplitude values is determined by UE and reported (i.e., one value of N_{ref} for all layers). The above examples can be the examples for all layers. The examples herein can be the example for all layers, instead of each layer.

In one example, for each of the above examples, equal-bit codebook (e.g., 3, 4-bit) can be used for reference amplitude values.

In another example, for each of the above examples, unequal-bit codebook (e.g., 2, 3, 4-bit) can be used for reference amplitude values.

In one embodiment, a UE is configured with one of (a subset of) the following grouping schemes for reference amplitude via RRC, MAC-CE, or DCI. Or the UE is configured to determine one of (a subset of) the following grouping schemes and to report.
Scheme 1: for reference amplitude, a group includes a TRP with both polarizations. Hence, the total number of groups for reference amplitude is N.
Scheme 2: for reference amplitude, a group includes a TRP with one polarization. Hence, the total number of groups for reference amplitude is 2N.
Scheme 3: for reference amplitude, a group includes a TRP group with both polarizations. Hence, the total number of groups for reference amplitude is G.
Scheme 4: for reference amplitude, a group includes a TRP group with one polarization. Hence, the total number of groups for reference amplitude is 2G.
Scheme 5: for reference amplitude, a group includes all TRPs with both polarizations. Hence, the total number of groups for reference amplitude is 1.
Scheme 6: for reference amplitude, a group includes all TRPs with one polarization. Hence, the total number of groups for reference amplitude is 2.

In one embodiment, a UE is configured with one of (a subset of) the following grouping schemes for reference phase via RRC, MAC-CE, or DCI. Or the UE is configured to determine one of (a subset of) the following grouping schemes for reference phase and to report.
Scheme 1: for reference amplitude, a group includes a TRP with both polarizations. Hence, the total number of groups for reference phase is N.
Scheme 2: for reference amplitude, a group includes a TRP with one polarization. Hence, the total number of groups for reference phase is 2N.
Scheme 3: for reference amplitude, a group includes a TRP group with both polarizations. Hence, the total number of groups for reference phase is G.
Scheme 4: for reference amplitude, a group includes a TRP group with one polarization. Hence, the total number of groups for reference phase is 2G.
Scheme 5: for reference amplitude, a group includes all TRPs with both polarizations. Hence, the total number of groups for reference phase is 1.
Scheme 6: for reference amplitude, a group includes all TRPs with one polarization. Hence, the total number of groups for reference phase is 2.

In one embodiment, for each layer l (layer-specific), the number of reference phase values (N_{ref,phase}) is 2N_{TRP} (or 2N). So, there are a total of 2N_{TRP}v (or 2Nv) reference phase values for v layers.

In one embodiment, for all layers l (layer-common), the number of reference phase values (N_{ref,phase}) is 2N_{TRP} (or 2N). So, there are a total of 2N_{TRP} (or 2N) reference phase values for u layers.

In one embodiment, for each layer l (layer-specific), the number of reference phase values (N_{ref,phase}) is 1 (i.e., TRP-common and polarization-common). So, there are a total of v reference phase values.

In one embodiment, for all layers l (layer-common), the number of reference phase values (N_{ref,phase}) is 1. So, there are a total of only 1 reference phase value for u layers.

In one embodiment, for each layer l (layer-specific), the number of reference phase values (N_{ref} phase) is N_{TRP} (or N). So, there are a total of N_{TRP} V (or Nv) reference phase values.

In one embodiment, for all layers l (layer-common), the number of reference phase values (N_{ref}.phase) is N_{TRP} (or N). So, there are a total of N_{TRP} (or N) reference phase value for v layers.

In one embodiment, for each layer l (layer-specific), the number of reference phase values (N_{ref} phase) is N_{ref}, where N_{ref} is the number of reference amplitude values. For example, any example of N_{ref} described in embodiments herein can be applied. In this case, there are a total of N_{ref} v reference phase value for v layers.

In one embodiment, for all layers l (layer-common), the number of reference phase values (N_{ref} phase) is N_{ref}, where N_{ref} is the number of reference amplitude values. For example, any example of N_{ref} described in embodiments herein can be applied. In this case, there are a total of N_{ref} reference phase value for v layers.

In one embodiment, for each layer l (layer-specific), the number of reference phase values (N_{ref,phase}) is

$$\frac{{N}_{ref}}{2} ,$$

where N_{ref} is the number of reference amplitude values. For example, any example of N_{ref} described in embodiments herein can be applied. In this case, there are a total of

$$\frac{{N}_{ref}}{2} v$$

reference phase value for u layers.

In one embodiment, for all layers l (layer-common), the number of reference phase values (N_{ref,phase}) is

$$\frac{{N}_{ref}}{2} ,$$

where N_{ref} is the number of reference amplitude values. For example, any example of N_{ref} described in embodiments herein can be applied. In this case, there are a total of

$$\frac{{N}_{ref}}{2}$$

reference phase value for v layers.

In one embodiment, for the mTRP codebook, W_{f} basis vectors (or indices of FD basis vectors) and W₂ FD indices (columns of W₂) or FD indices of coefficients are shifted (or rotated or remapping) based on or with respect to the FD beam index f*, which can be reference FD beam index.

In Rel-16 Type-II codebook, the remapping procedure is as follows [REF9]: Let

$${f}_{l}^{*} ∈ \{ 0 , 1 , … , {M}_{υ} - 1 \}$$

be the index of i_{2,4,l} and

$${i}_{l}^{*} ∈ \{ 0 , 1 , … , 2 L - 1 \}$$

be the index of

$${k}_{l , {f}_{l}^{⋆}}^{( 2 )}$$

which identify the strongest coefficient of layer l, i.e., the element

$${k}_{l , {i}_{l}^{⋆} , {f}_{l}^{⋆}}^{( 2 )}$$

of i_{2,4,l}, for l=1, . . . , v. The codebook indices of n_{3,l} are remapped with respect to

$${n}_{3 , l}^{( {f}_{l}^{*} )} as {n}_{3 , l}^{( f )} = ( {n}_{3 , l}^{( f )} - {n}_{3 , l}^{( {f}_{l}^{*} )} )$$

mod N₃, such that

$${n}_{3 , l}^{( {f}_{l}^{*} )} = 0 ,$$

after remapping. The index f is remapped with respect to

$${f}_{l}^{*} as f = ( f - {f}_{l}^{*} ) mod {M}_{υ} ,$$

such that the index of the strongest coefficient is

$${f}_{l}^{*} = 0 ( l = 1 , … , υ ) ,$$

after remapping. The indices of i_{2,4,l}, i_{2,5,l} and i_{1,7,l} indicate amplitude coefficients, phase coefficients and bitmap after remapping.

In one example, the strongest coefficient of layer l is identified by i_{1,8,l}∈{0,1, . . . , 2L−1}, which is obtained as follows

$${i}_{1 , 8 , l} = \{ \begin{matrix}{\sum }_{i = 0}^{{i}_{1}^{*}} {k}_{1 , i , 0}^{( 3 )} - 1 & υ = 1 \\ {i}_{l}^{*} & 1 < υ \leq 4\end{matrix}$$

for l=1, . . . , v.

In one example, the strongest coefficient of layer l is identified by i_{1,8,l}∈{0,1, . . . , 2L−1}, which is obtained as follows

$${i}_{1 , 8 , l} = {i}_{l}^{*}$$

for all rank v∈{1, . . . , 4} and for l=1, . . . , v.

In one example, the reference FD beam index f* is the FD beam index f of the SCI (of the strongest TRP). The SCI hence the index f* is layer-common, i.e., the same for all layers.

In one example, the reference FD beam index f* is fixed (e.g., the lowest index among the FD basis vectors). The fixed index f* is layer-common, i.e., the same for all layers.

In one example, the reference FD beam index f* is a configured, via, DCI, MAC-CE, or RRC by NW (layer-common). The configured index can be one of indices of FD basis vectors. Or the configured index can be different from indices of FD basis vectors. The configured index f* is layer-common, i.e., the same for all layers.

In one example, W_{f} basis vectors and W₂ FD indices (columns of W₂) associated with the strongest TRP are shifted (or rotate or remapping FD indices) based on the FD beam index f*, where f* is according to one of the above examples. For the rest of the TRPs, the shift or rotation or remapping may not be performed. The index f* is layer-common, i.e., the same for all layers.

In one example, W_{f} basis vectors and W₂ FD indices (columns of W₂) associated with all TRPs are shifted (or rotated or remapping FD indices) based on the FD beam index f*, where f* is according to one of the above examples.

In one example, the reference FD beam index

$${f}_{l}^{*}$$

is the FD beam index fₗ of the SCI (of the strongest TRP) for each layer l. The SCI hence the index

$${f}_{l}^{*}$$

is layer-specific, i.e., one SCI for each layer.

In one example, the reference FD beam index

$${f}_{l}^{*}$$

is fixed (e.g., the lowest ndext among the FD basis vectors) for each layer l. The fixed index

$${f}_{l}^{*}$$

is layer-specific, i.e., one SCI foreach layer. each layer.

In one example, the reference FD beam index

$${f}_{l}^{*}$$

is a configured, via, DCI, MAC-CE, or RRC by NW (layer-specific). The configured index can be one of indices of FD basis vectors. Or the configured index can be different from indices of FD basis vectors. The configured index

$${f}_{l}^{*}$$

is layer-specific, i.e., one for each layer.

In one example, W_{f} basis vectors and W₂ FD indices (columns of W₂) associated with the strongest TRP are shifted (or rotate or remapping FD indices) based on the FD beam index

$${f}_{l}^{*} ,$$

where

$${f}_{l}^{*}$$

is according to one of the above examples (2.1.6 through 2.1.8). For the rest of the TRPs, the shift or rotation or remapping may not be performed. The index fₗ* is layer-specific, i.e., one for each layer.

In one example, W_{f} basis vectors and W₂ FD indices (columns of W₂) associated with all TRPs are shifted (or rotated or remapping FD indices) based on the FD beam index

$${f}_{l}^{*} ,$$

where

$${f}_{l}^{*}$$

is according to one of the above examples (2.1.6 through 2.1.8).

In one embodiment, reference amplitude/phase values (and corresponding groups of coefficients) on W₂ quantization group and SCI(s) (for each layer) are according to at least one of the followings examples/alternatives:
In one alternative: one group comprises one polarization across all TRPs/TRP-groups (C_{group,phase}=1, C_{group,amp}=2), one (common) SCI across all TRPs/TRP groups.
   This alternative is similar to one or more examples herein, and/or one or more embodiments herein.
In one alternative: One group comprises one polarization for one TRP/TRP-group (C_{group,phase}=N, C_{group,amp}=2N) per-TRP/TRP-group SCI.
   This alternative is a simple extension of Rel-16/17 Type-II reference amplitude/phase grouping from single-TRP case to multi-TRP case (N_{TRP}>1).
In one alternative: One group comprises one polarization for one TRP/TRP-group with a common phase reference across TRPs/TRP-groups (C_{group,phase}=1, C_{group,amp}=2N).
   This alternative is similar to one or more examples herein, and/or one or more embodiments herein.
In one alternative: For 1 TRP/TRP-group, one group comprises one polarization, and for remaining N−1 TRPs, one group comprises one polarization across remaining N−1 TRPs/TRP-groups (C_{group,amp}=2+²=4), with a common phase reference across TRPs/TRP-groups (C_{group,phase}=1).
   This alternative is similar to one or more examples herein, and/or one or more embodiments herein.

In one example, for the 1TRP/TRP-group in Alt4, it can be a reference TRP r* (e.g., strongest TRP (TRP-group) as described in embodiments herein, which can be according to at least one of the following examples.
In one example, the reference TRP r* is configured by NW via DCI, MAC-CE, or DCI.
In one example, the reference TRP r* is determined by UE (e.g., the strongest TRP). In one example, the reference TRP r* can be explicitly or implicitly reported.

In one example, multiple of alternatives in the above are supported/specified, one of them can be configured via higher layer (RRC) or MAC CE or DCI.

In one embodiment, a UE is configured with a CSI reporting based on an mTRP (or D-MIMO or C-JT) codebook, via e.g., higher layer parameter codebookType set to ‘typeII-r18-cjt’ or ‘typeII-PortSelection-r18-cjt’, where the codebook is one of the following two modes: In one example, one of the two modes is configured, e.g., via higher layer (e.g., via parameter codebookMode)
Mode 1: Per-TRP/TRP-group SD/FD basis selection. Example formulation (N_{TRP}=number of TRPs or TRP groups): The UE reports (i) SD basis vectors for each TRP, (ii) FD basis vectors for each TRP, and (iii) either a joint W2 across all TRPs or one W2 for each TRP.

$$[ \begin{matrix}{W}_{1 , 1} {\tilde{W}}_{2 , 1} {W}_{f , 1}^{H} \\ ⋮ \\ {W}_{1 , N} {\tilde{W}}_{2 , N} {W}_{f , N}^{H}\end{matrix} ]$$

Mode 2: Per-TRP/TRP group (port-group or resource) SD basis selection and joint (across N_{TRP}TRPs) FD basis selection. Example formulation (N_{TRP}=number of TRPs or TRP groups): The UE reports (i) SD basis vectors for each TRP, (ii) one common/joint FD basis vectors across all TRPs, and (iii) either a joint W2 across all TRPs or one W2 for each TRP.

$$[ \begin{matrix}{W}_{1 , 1} & & 0 & 0 & 0 \\ 0 & & ⋱ & 0 & 0 \\ 0 & 0 & & & \\ 0 & 0 & & {W}_{1 , N} & \end{matrix} ] {\tilde{W}}_{2} {W}_{f}^{H} or [ \begin{matrix}{W}_{1 , 1} {\tilde{W}}_{2 , 1} {W}_{f , 1}^{H} \\ ⋮ \\ {W}_{1 , N} {\tilde{W}}_{2 , N} {W}_{f , N}^{H}\end{matrix} ]$$

Here, we may use N and N_{TRP} interchangeably.

In one example, Mode 1 can be the codebook described in one or more embodiments of U.S. Prov. App. No. 63/398,436, and Mode 2 can be the codebook described in one or more embodiments of U.S. Prov. App. No. 63/398,436.

In one example, the two modes can share similar detailed designs such as parameter combinations, basis selection, TRP (group) selection, reference amplitude, \tilde{W}₂ quantization schemes.
In one example, parameter combinations can be a tuple of parameters such as L, pᵥ, β for regular Type-II CJT codebook or a tuple of parameters such as M, α, β for port-selection Type-II CJT codebook.
In one example, basis selection scheme can be SD basis selection and/or FD basis selection schemes described herein.
In one example, a TRP selection can be one component/example described in U.S. Prov. App. No. 63/359,658.
In one example, a reference amplitude scheme can be one component/example described in U.S. Prov. App. No. 63/343,847.
In one example, a \tilde{W}₂ quantization scheme can include strongest coefficient indicator, upper bound of non-zero coefficients, reference amplitudes, a scheme that each coefficient is decomposed into phase and amplitude, and they are selected respective codebooks, and a codebook subset restriction.

In one embodiment, reference amplitude/phase design methods (Alt1-Alt4) described herein are applied/used in Mode 1 and/or Mode 2.

In Rel-16/17 Type-II codebook, amplitude quantization scheme for W₂ is in a differential manner, i.e., each amplitude value is computed as p⁽¹⁾p⁽²⁾ where p⁽¹⁾ is a reference amplitude value, and p⁽²⁾ is a (differential) coefficient amplitude value. There are two reference amplitude values

$${p}_{l}^{( 1 )} = [ \begin{matrix}{p}_{l , 0}^{( 1 )} & {p}_{l , 1}^{( 1 )}\end{matrix} ]$$

for layer l=1, . . . , v in [REF9] wherein one reference value corresponding to the SCI is set to

$$1 ( hence not reported , i . e . , {k}_{l , ⌊ \frac{{i}_{l}^{*}}{L} ⌋}^{( 1 )} = 15 , {k}_{l , {i}_{l}^{*} , 0}^{( 2 )} = 7 , {k}_{l , {i}_{l}^{*} , 0}^{( 3 )} = 1 and {c}_{l , {i}_{l}^{*} , 0} = 0 ) ,$$

and the other reference value, which corresponds to the other polarization of the coefficient of the SCI, is selected from 4-bit amplitude codebook, Table 5.2.2.2.5-2 in [REF9], and is reported (i.e., the indicator

$${k}_{l , ( ⌊ \frac{{i}_{l}^{*}}{L} ⌋ + 1 ) mod 2}^{( 1 )}$$

is reported). For p⁽²⁾, please refer to [REF9] in detail.

In one example, for Alt1, the amplitude coefficients can be represented by

$${p}_{l}^{( 1 )} = [ \begin{matrix}{p}_{l , 0}^{( 1 )} & {p}_{l , 1}^{( 1 )}\end{matrix} ]$$

for layer l=1, . . . , v.

In one example, for Alt1, the amplitude coefficients can be represented by

$${p}_{r , l}^{( 1 )} = [ \begin{matrix}{p}_{r , l , 0}^{( 1 )} & {p}_{r , l , 1}^{( 1 )}\end{matrix} ] = [ \begin{matrix}{p}_{l , 0}^{( 1 )} & {p}_{l , 1}^{( 1 )}\end{matrix} ]$$

for ∀r=1, . . . , N and for layer l=1, . . . , v.

In one example, for Alt2, the amplitude coefficients can be represented by

$${p}_{r , l}^{( 1 )} = [ \begin{matrix}{p}_{r , l , 0}^{( 1 )} & {p}_{r , l , 1}^{( 1 )}\end{matrix} ]$$

where TRP r=1, . . . , N and layer l=1, . . . , v.

In one example, for Alt3, the amplitude coefficients can be represented by

$${p}_{r , l}^{( 1 )} = [ \begin{matrix}{p}_{r , l , 0}^{( 1 )} & {p}_{r , l , 1}^{( 1 )}\end{matrix} ]$$

where TRP r=1, . . . , N and layer l=1, . . . , v.

In one example, for Alt4, the amplitude coefficients can be represented by

$${p}_{{r}^{*} , l}^{( 1 )} = [ \begin{matrix}{p}_{0 , l , 0}^{( 1 )} & {p}_{0 , l , 1}^{( 1 )}\end{matrix} ]$$

where TRP r* is a reference/strongest TRP index and for ∀r′≠r*,

$${p}_{{r}^{′} , l}^{( 1 )} = [ {p}_{1 , 0}^{( 1 )} {p}_{1 , 0}^{( 1 )} ]$$

and layer l=1, . . . , v.

Any examples on Alt1-Alt4 described above can be applied in any of the following examples/embodiment.
In one example, the reference amplitude/phase design method of Alt3 herein is applied/used in Mode 1, and the reference amplitude/phase design method of Alt1 herein is applied/used in Mode 2.
In one example, the reference amplitude/phase design method of Alt1 herein is applied/used in Mode 1, and the reference amplitude/phase design method of Alt3 herein is applied/used in Mode 2.
In one example, the reference amplitude/phase design method of Alt3 herein is applied/used in Mode 1, and the reference amplitude/phase design method of Alt4 herein is applied/used in Mode 2.
In one example, the reference amplitude/phase design method of Alt4 herein is applied/used in Mode 1, and the reference amplitude/phase design method of Alt3 herein is applied/used in Mode 2.
In one example, the reference amplitude/phase design method of Alt4 herein is applied/used in Mode 1, and the reference amplitude/phase design method of Alt1 herein is applied/used in Mode 2.
In one example, the reference amplitude/phase design method of Alt1 herein is applied/used in Mode 1, and the reference amplitude/phase design method of Alt4 herein is applied/used in Mode 2.
In one example, the reference amplitude/phase design method of Alt2 herein is applied/used in Mode 1, and the reference amplitude/phase design method of Alt1 herein is applied/used in Mode 2.
In one example, the reference amplitude/phase design method of Alt1 herein is applied/used in Mode 1, and the reference amplitude/phase design method of Alt2 herein is applied/used in Mode 2.
In one example, the reference amplitude/phase design method of Alt2 herein is applied/used in Mode 1, and the reference amplitude/phase design method of Alt3 herein is applied/used in Mode 2.
In one example, the reference amplitude/phase design method of Alt3 herein is applied/used in Mode 1, and the reference amplitude/phase design method of Alt2 herein is applied/used in Mode 2.
In one example, the reference amplitude/phase design method of Alt2 herein is applied/used in Mode 1, and the reference amplitude/phase design method of Alt4 herein is applied/used in Mode 2.
In one example, the reference amplitude/phase design method of Alt4 herein is applied/used in Mode 1, and the reference amplitude/phase design method of Alt2 herein is applied/used in Mode 2.
In one example, for Mode 1, either the reference amplitude/phase design method of Alt1 or the reference amplitude/phase design method of Alt3 herein can be configured via RRC, MAC-CE or DCI, and for Mode 2, the reference amplitude/phase design method of Alt1 herein is applied/used.
In one example, for Mode 2, either the reference amplitude/phase design method of Alt1 or the reference amplitude/phase design method of Alt3 herein can be configured via RRC, MAC-CE or DCI, and for Mode 1, the reference amplitude/phase design method of Alt1 herein is applied/used.
In one example, for Mode 1, either the reference amplitude/phase design method of Alt1 or the reference amplitude/phase design method of Alt3 herein can be configured via RRC, MAC-CE or DCI, and for Mode 2, the reference amplitude/phase design method of Alt3 herein is applied/used.
In one example, for Mode 2, either the reference amplitude/phase design method of Alt1 or the reference amplitude/phase design method of Alt3 herein can be configured via RRC, MAC-CE or DCI, and for Mode 1, the reference amplitude/phase design method of Alt3 herein is applied/used.
In one example, for Mode 1 and Mode 2, either the reference amplitude/phase design method of Alt1 or the reference amplitude/phase design method of Alt3 herein can be configured via RRC, MAC-CE or DCI.

In one embodiment, for reporting reference amplitudes, a UE is configured to report reference amplitudes according to at least one of the following examples.
In one example, when Alt2 described herein is considered, 2N−1 reference amplitudes are reported, and 1 reference amplitude (associated with the SCI) is not reported.
In one example, when Alt2 described herein is considered, 2N reference amplitudes are reported.
In one example, when Alt3 described herein is considered, 2N−1 reference amplitudes are reported, and 1 reference amplitude (associated with the SCI) is not reported.
In one example, when Alt3 described herein is considered, 2N reference amplitudes are reported.
In one example, when Alt4 described herein is considered, 3 reference amplitudes are reported and 1 reference amplitude (associated with the SCI) is not reported.
In one example, when Alt4 described herein is considered, 4 reference amplitudes are reported.
In one example, when Alt1 described herein is considered, 1 reference amplitude are reported and 1 reference amplitude (associated with the SCI) is not reported.
In one example, when Alt1 described herein is considered, 2 reference amplitudes are reported.

In one embodiment, a UE is configured to report which reference amplitude/phase design methods are selected via CSI part 1.
In one example, when Mode 1 is configured, one of the reference amplitude/phase design methods Alt1 and Alt3 described herein is selected and reported via CSI part 1. When Mode 2 is configured, the reference amplitude/phase design methods Alt1 described herein is applied/used (no selection and no reporting required).
In one example, when Mode 1 is configured, one of the reference amplitude/phase design methods Alt1 and Alt3 described herein is selected and reported via CSI part 1. When Mode 2 is configured, the reference amplitude/phase design methods Alt3 described herein is applied/used (no selection and no reporting required).
In one example, when Mode 2 is configured, one of the reference amplitude/phase design methods Alt1 and Alt3 described herein is selected and reported via CSI part 1. When Mode 1 is configured, the reference amplitude/phase design methods Alt1 described herein is applied/used (no selection and no reporting).
In one example, when Mode 2 is configured, one of the reference amplitude/phase design methods Alt1 and Alt3 described herein is selected and reported via CSI part 1. When Mode 1 is configured, the reference amplitude/phase design methods Alt2 described herein is applied/used (no selection and no reporting).
In one example, when Mode 1 is configured, one of the reference amplitude/phase design methods Alt1 and Alt3 described herein is selected and reported via CSI part 1. When Mode 2 is configured, one of the reference amplitude/phase design methods Alt1 and Alt3 described herein is selected and reported via CSI part 1.

In one embodiment, a UE reports UE capability on reference amplitude/phase design methods that the UE supports, and NW configures it, following the reported UE capability. The UE capability reporting can be at least one of the following examples.
In one example, the UE can report UE capability on supporting only the reference amplitude/phase design method of Alt1, and NW can configure the Alt1 method only for the UE.
In one example, the UE can report UE capability on supporting only the reference amplitude/phase design method of Alt3, and NW can configure the Alt3 method only for the UE.
In one example, the UE can report UE capability on supporting both the reference amplitude/phase design methods of Alt1 and Alt3, and NW can configure either Alt1 or Alt3 method for the UE.
In one example, when Mode 1 is configured, the UE can report UE capability on supporting only the reference amplitude/phase design method of Alt1, and NW can configure the Alt1 method only for the UE.
In one example, when Mode 1 is configured, the UE can report UE capability on supporting only the reference amplitude/phase design method of Alt3, and NW can configure the Alt3 method only for the UE.
In one example, when Mode 1 is configured, the UE can report UE capability on supporting both the reference amplitude/phase design methods of Alt1 and Alt3, and NW can configure either Alt1 or Alt3 method for the UE.
In one example, when Mode 2 is configured, the UE can report UE capability on supporting only the reference amplitude/phase design method of Alt1, and NW can configure the Alt1 method only for the UE.
In one example, when Mode 2 is configured, the UE can report UE capability on supporting only the reference amplitude/phase design method of Alt3, and NW can configure the Alt3 method only for the UE.
In one example, when Mode 2 is configured, the UE can report UE capability on supporting both the reference amplitude/phase design methods of Alt1 and Alt3, and NW can configure either Alt1 or Alt3 method for the UE.
In one example, when either Model or Mode 2 is configured, the UE can report UE capability on supporting only the reference amplitude/phase design method of Alt1, and NW can configure the Alt1 method only for the UE.
In one example, when either Model or Mode 2 is configured, the UE can report UE capability on supporting only the reference amplitude/phase design method of Alt3, and NW can configure the Alt3 method only for the UE.
In one example, when either Model or Mode 2 is configured, the UE can report UE capability on supporting both the reference amplitude/phase design methods of Alt1 and Alt3, and NW can configure either Alt1 or Alt3 method for the UE.
In one example, when Mode 1 with FD basis selection offsets selected from a set including oversampling factor (i.e., for fraction offsets or oversampled offsets) is configured, the UE can report UE capability on supporting the reference amplitude/phase design method of Alt3, and NW can configure the Alt3 method for the UE.
In one example, when Mode 1 with FD basis selection offsets selected from a set including oversampling factor (i.e., for fraction offsets or oversampled offsets) is configured, the UE can report UE capability on supporting only the reference amplitude/phase design method of Alt1, and NW can configure the Alt1 method for the UE.

In one embodiment, on RRC parameter [symbol] for reference amplitude/phase design methods of Alt1 and Alt3 described herein, the parameter [symbol] (or Information Element (IE)) can include A₁ or A₂.
In one example, A₁=‘2’ and A₂=‘2N’. Here ‘2’ corresponds to Alt1 and ‘2N’ corresponds to Alt3.
In one example, A₁=‘Scheme1’ and A₂=‘Scheme2’. Here ‘Scheme1’ corresponds to Alt1 and ‘Scheme2’ corresponds to Alt3.
In one example, A₁=‘Scheme1’ and A₂=‘Scheme2’. Here ‘Scheme1’ corresponds to Alt3 and ‘Scheme2’ corresponds to Alt1.
In one example, A₁=‘1’ and A₂=‘2’. Here ‘1’ corresponds to Alt1 and ‘2’ corresponds to Alt2.
In one example, A₁=‘1’ and A₂=‘2’. Here ‘2’ corresponds to Alt1 and ‘1’ corresponds to Alt2.
In one example, A₁=‘Method1’ and A₂=‘Method2’. Here ‘Method1’ corresponds to Alt1 and ‘Method2’ corresponds to Alt2.
In one example, A₁=‘Method1’ and A₂=‘Method2’. Here ‘Method2’ corresponds to Alt1 and ‘Method1’ corresponds to Alt2.

In one example, the RRC parameter [symbol] can be named as ‘referenceAmp’, ‘referenceAmpScheme’, ‘referenceAmpMethod’, or ‘nrofReferenceAmps’, but it should not be limited to the names. Other examples for naming can be considered.

FIG. 13 illustrates a flowchart of an example method for operating a UE according to embodiments of the present disclosure. The method 1300 of FIG. 13 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1300 is for illustration only and other embodiments can be used without departing from the scope of the present disclosure.

The method begins with the UE receiving information about a CSI report (1310). For example, in 1310, the information indicates Nₜᵣₚ CSI-RS resources, where Nₜᵣₚ>1. The UE then measures the Nₜᵣₚ CSI-RS resources (1320). For example, in 1320, the UE may perform the measurement based on the received information.

The UE then determines the CSI report associated with N≤Nₜᵣₚ CSI-RS resources (1330). For example, in 1330, the UE determines the CSI report based on the received information and N∈{1,2, . . . , Nₜᵣₚ}. In various embodiments, the CSI report includes a strongest coefficient indicator (SCI) for each layer l (SCIₗ) and the SCIₗ indicates an index of a strongest coefficient among

$${K}_{l}^{NZ}$$

coefficients, where l∈{1, . . . , v} is a layer index, v≥1 is a rank value, and

$${K}_{l}^{NZ}$$

is a total number of non-zero coefficients for a layer l associated with CSI-RS ports corresponding to the N CSI-RS resources. In various embodiments, a payload of the SCIₗ is ┌log₂ K^{NZ}┐ bits when v=1, and

$$⌈ {log}_{2} 2 {\sum }_{r = 1}^{N} {L}_{r} ⌉$$

bits when v>1, where K^{NZ} is a total number of non-zero coefficients.

In various embodiments, to determine the CSI report, the UE determines two first amplitude coefficients for each layer l=1, . . . , v, where one of the two first amplitude coefficients corresponds to a first group of coefficients, a remaining one of the two first amplitude coefficients corresponds to a second group of coefficients. For example, the first group of coefficients includes second amplitude coefficients

$${p}_{l , {i}_{r} , m , r}^{( 2 )}$$

with an index iᵣ=0, 1, . . . , Lᵣ−1 and the second group of coefficients includes second amplitude coefficients

$${p}_{l , {i}_{r} , m , r}^{( 2 )}$$

with an index iᵣ=Lᵣ, Lᵣ+1, . . . , 2Lᵣ−1. Lᵣ is a number of spatial domain (SD) basis vectors for a CSI-RS resource r, m is an index of a frequency domain (FD) vector, and r=1,2 . . . , N. For example, for each layer l=1, 2, . . . , v, one of the two first amplitude coefficients corresponding to a group including a strongest coefficient among the second amplitude coefficients

$${p}_{l , {i}_{r} , m , r}^{( 2 )}$$

is set to 1, one of the two first amplitude coefficients is not reported, and a remaining one of the two first amplitude coefficients is reported. For example, for each layer l=1, . . . , v, the CSI report further includes an indicator, the indicator indicates the reported one of the two first amplitude coefficients, and a size of the indicator is 4 bits indicating one of

$$\{ R , {( \frac{1}{{2}^{14}} )}^{\frac{1}{4}} , … , {( \frac{1}{8} )}^{\frac{1}{4}} , {( \frac{1}{4} )}^{\frac{1}{4}} , {( \frac{1}{2} )}^{\frac{1}{4}} , 1 \} ,$$

where R denotes a reserved state.

In various embodiments, to determine the CSI report, the UE determines 2N first amplitude coefficients for each layer l=1, . . . , v, where each of the 2N first amplitude coefficients correspond to a k-th group of coefficients for k=1,2, . . . ,2N, a (2r−1)-th group of coefficients includes second amplitude coefficients

$${p}_{l , {i}_{r} , m , r}^{( 2 )}$$

with an index iᵣ=0, 1, . . . , Lᵣ−1, and a (2r)-th group of coefficients includes second amplitude coefficients

$${p}_{l , {i}_{r} , m , r}^{( 2 )}$$

with an index iᵣ=Lᵣ, Lᵣ+1, . . . , 2Lᵣ−1, where Lᵣ is a number of spatial domain (SD) basis vectors for CSI-RS resource r, m is an index of a frequency domain (FD) vector, and r=1,2 . . . , N. For example, for each layer l=1, 2, . . . , v, one of the 2N first amplitude coefficients corresponding to a group including a strongest coefficient among the second amplitude coefficients

$${p}_{l , {i}_{r} , m , r}^{( 2 )}$$

is set to 1, one of the 2N first amplitude coefficients is not reported, and a remaining 2N−1 first amplitude coefficients are reported. For example, for each layer l=1, . . . , v, the CSI report further includes an indicator, the indicator indicates each of the remaining 2N−1 first amplitude coefficients, and a size of the indicator is 4 bits indicating one of

$$\{ R , {( \frac{1}{{2}^{14}} )}^{\frac{1}{4}} , … , {( \frac{1}{8} )}^{\frac{1}{4}} , {( \frac{1}{4} )}^{\frac{1}{4}} , {( \frac{1}{2} )}^{\frac{1}{4}} , 1 \} ,$$

where R denotes a reserved state.

The UE then transmits the CSI report (1340).

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a transceiver configured to receive information associated with a channel state information (CSI) report, the information indicating Nₜᵣₚ CSI reference signal (CSI-RS) resources, where Nₜᵣₚ≥1; and
a processor operably coupled with the transceiver, the processor configured to measure N CSI-RS resources selected among the Nₜᵣₚ CSI-RS resources, where Nₜᵣₚ≥N,
wherein the transceiver is further configured to transmit the CSI report including a reference amplitude coefficient indicator based on the N CSI-RS resources,
wherein the reference amplitude coefficient indicator is configured based on two elements which are mapped to a first reference amplitude coefficient and a second reference amplitude coefficient, respectively,
wherein one element of the two elements, which is associated with a strongest coefficient identified within coefficients of the N CSI-RS resources, is not reported, and
wherein another one element of the two elements is reported.

2. The UE of claim 1, wherein:
the CSI report further includes an amplitude coefficient indicator and a strongest coefficient indicator indicating the strongest coefficient,
the amplitude coefficient indicator includes N element groups which are associated with the N CSI-RS resources, respectively,
each of the N element groups includes at least one element which is mapped to an amplitude coefficient, respectively, and
one element of all elements including the at least one element of each of the N element groups corresponding to the strongest coefficient is not reported in the amplitude coefficient indicator.

3. The UE of claim 2, wherein the first reference amplitude coefficient and the second reference amplitude coefficient are commonly applied for each of the N element groups included in the amplitude coefficient indicator.

4. The UE of claim 2, wherein:
the one element of the two elements, which is associated with the strongest coefficient, is mapped to the first reference amplitude coefficient, and
the other one element of the two elements is mapped to the second reference amplitude coefficient and reported using 4 bits indicating one of indicating one of
$$\{ {( \frac{1}{{2}^{14}} )}^{\frac{1}{4}} , … , {( \frac{1}{8} )}^{\frac{1}{4}} , {( \frac{1}{4} )}^{\frac{1}{4}} , {( \frac{1}{2} )}^{\frac{1}{4}} , 1 \} .$$

5. A base station in a wireless communication system, the base station comprising:
a processor; and
a transceiver operably coupled with the processor, the transceiver configured to:
transmit information associated with a channel state information (CSI) report, the information indicating Nₜᵣₚ CSI reference signal (CSI-RS) resources, where Nₜᵣₚ≥1, and
receive the CSI report including a reference amplitude coefficient indicator based on N CSI-RS resources selected among the Nₜᵣₚ CSI-RS resources, where Nₜᵣₚ≥ N,
wherein the reference amplitude coefficient indicator is configured based on two elements which are mapped to a first reference amplitude coefficient and a second reference amplitude coefficient, respectively,
wherein one element of the two elements, which is associated with a strongest coefficient identified within coefficients of the N CSI-RS resources, is not reported, and
wherein another one element of the two elements is reported.

6. The base station of claim 5, wherein:
the CSI report further includes an amplitude coefficient indicator and a strongest coefficient indicator indicating the strongest coefficient,
the amplitude coefficient indicator includes N element groups which are associated with the N CSI-RS resources, respectively,
each of the N element groups includes at least one element which is mapped to an amplitude coefficient, respectively, and
one element of all elements including the at least one element of each of the N element groups corresponding to the strongest coefficient is not reported in the amplitude coefficient indicator.

7. The base station of claim 6, wherein the first reference amplitude coefficient and the second reference amplitude coefficient are commonly applied for each of the N element groups included in the amplitude coefficient indicator.

8. The base station of claim 6, wherein:
the one element of the two elements, which is associated with the strongest coefficient, is mapped to the first reference amplitude coefficient, and
the other one element of the two elements is mapped to the second reference amplitude coefficient and reported using 4 bits indicating one of indicating one of
$$\{ {( \frac{1}{{2}^{14}} )}^{\frac{1}{4}} , … , {( \frac{1}{8} )}^{\frac{1}{4}} , {( \frac{1}{4} )}^{\frac{1}{4}} , {( \frac{1}{2} )}^{\frac{1}{4}} , 1 \} .$$

9. A method performed by a user equipment (UE) in a wireless communication system, the method comprising:
receiving information associated with a channel state information (CSI) report, the information indicating Nₜᵣₚ CSI reference signal (CSI-RS) resources, where Nₜᵣₚ≥1;
measuring N CSI-RS resources selected among the Nₜᵣₚ CSI-RS resources, where Nₜᵣₚ≥N; and
transmitting the CSI report including a reference amplitude coefficient indicator, based on the N CSI-RS resources,
wherein the reference amplitude coefficient indicator is configured based on two elements which are mapped to a first reference amplitude coefficient and a second reference amplitude coefficient, respectively,
wherein one element of the two elements, which is associated with a strongest coefficient identified within coefficients of the N CSI-RS resources, is not reported, and
wherein another one element of the two elements is reported.

10. The method of claim 9, wherein:
the CSI report further includes an amplitude coefficient indicator and a strongest coefficient indicator indicating the strongest coefficient,
the amplitude coefficient indicator includes N element groups which are associated with the N CSI-RS resources, respectively,
each of the N element groups includes at least one element which is mapped to an amplitude coefficient, respectively, and
one element of all elements including the at least one element of each of the N element groups corresponding to the strongest coefficient is not reported in the amplitude coefficient indicator.

11. The method of claim 10, wherein the first reference amplitude coefficient and the second reference amplitude coefficient are commonly applied for each of the N element groups included in the amplitude coefficient indicator.

12. The method of claim 10, wherein:
the one element of the two elements, which is associated with the strongest coefficient, is mapped to the first reference amplitude coefficient, and
the other one element of the two elements is mapped to the second reference amplitude coefficient and reported using 4 bits indicating one of indicating one of
$$\{ {( \frac{1}{{2}^{14}} )}^{\frac{1}{4}} , … , {( \frac{1}{8} )}^{\frac{1}{4}} , {( \frac{1}{4} )}^{\frac{1}{4}} , {( \frac{1}{2} )}^{\frac{1}{4}} , 1 \} .$$
